(19) United States
(12) Patent Application Publication
(10) Pub. No.: US 2008/0168515 A1
(43) Pub. Date: Jul. 10, 2008

(54) SYSTEM AND METHOD FOR DELIVERY OF MEDIA CONTENT TO A USER

(76) Inventors: Ronald G. Benson, Boulder, CO (US); David Erikson, Boulder, CO (US); Chad Thompson, Louisville, CO (US); Greg Jewett, Lafayette, CO (US)

Correspondence Address: COOLEY GODWARD KRONISH LLP;ATTN: Patent Group, Suite 1100, 777 - 6th Street, NW, WASHINGTON, DC, 20001, US

(21) Appl. No.: 11/963,986

(22) Filed: Dec. 24, 2007

Related U.S. Application Data
(60) Provisional application No. 60/877,411, filed on Dec. 26, 2006.

(51) Int. Cl. H04N 7/173

(52) U.S. Cl. 725/110

(57) ABSTRACT

A system and method for providing media content to a content subscriber is described. One embodiment includes a media device for controlling access to media content. The media apparatus comprises a processor, a memory and a storage device housing to may house a storage device. The media apparatus further comprises a media database that stores information about media content residing on the storage device. The media apparatus may also comprise one or more communication interfaces for communicating with a content provider, the storage device or other devices. The media apparatus may also include a real-time clock to maintain the current time and date. Further, the media apparatus may comprise a viewing policy engine for controlling access to the media content on the storage device. Lastly, the media apparatus comprises a rental agreement engine for enforcing a rental policy associated with a storage device.

### PRIORITY

The present application claims priority from commonly owned and assigned provisional application No. 60/877,411, Attorney Docket No. MORP-001/00US, entitled Method for Delivering a Media Collection for Rental of Individual Media Elements, which is incorporated herein by reference.

### COPYRIGHT

A portion of the disclosure of this patent document contains material that is subject to copyright protection. The copyright owner has no objection to the facsimile reproduction by anyone of the patent disclosure, as it appears in the Patent and Trademark Office patent files or records, but otherwise reserves all copyright rights whatsoever.

### FIELD OF THE INVENTION

The present invention relates to delivery of media content. In particular, but not by way of limitation, the present invention relates to systems and methods for delivering media content to an end user.

### BACKGROUND OF THE INVENTION

With the advent of the Internet, digital and satellite television, numerous methods of delivering media content to end users have emerged. A decade ago, movie rental stores were the only means for renting movies. A user would go to a rental store and rent a movie for a fixed rate for a fixed period of time. Whether the user watched the movie or not, they were charged for its rental. If the user failed to return the movie on time, they were charged additional rental fees.

As the Internet, digital cable and satellite television matured, additional movie rental models evolved. Rental models such as Netflix™ appeared. Such a model allowed for the selection of movies over the Internet, followed by the delivery of movies via postal mail. This model further requires a monthly subscription wherein a fixed price is associated with a maximum number of concurrently rented movies. For example, for $12/month subscription fee, a user may rent as many movies during the month as they wish. However, the user may only have two movies rented at a time. Additional monthly fees allowed for an increase in the number of movies that may be concurrently rented. However, there are downsides to such a model as well. There is a waiting period for receiving movies from the time they are ordered until the time they arrive. This timeframe is typically 2-3 days. Additionally, a user is drastically limited by the number of movies they may rent at one time. Most online rental services limit rentals to no more than 3-4 movies at a time. Lastly, DVDs are prone to scratching after a few rentals. The average home user fails to care for the disk as if it were their own. Hence, it is common to receive DVDs in the mail that are scratched, making the movie unwatchable.

Digital cable and satellite television eliminated the above waiting period by offering on demand movie rentals. A user could rent a movie through a graphical interface provided by the cable or satellite receiver. Receipt of the movie was instantaneous, permitting the user to begin viewing the movie upon payment. However, such a model required the user to watch the movie front start to finish. If the user was unable to complete the movie in one sitting, they were often required to re-rent the movie if they wished to watch it to the end. Additionally, if they want to watch the movie a second time, the next day for example, an additional rental charge was normally incurred. Lastly, these models do not permit mobile viewing, as the user is tied to watching from a television directly wired to the set top box.

Other rental models allow for rental of movies over the Internet, such that the movie is streamed to a user's computer while they are watching it. However, such a model requires a constant Internet connection, making mobility difficult. Additional rental models permit a user to download a movie in its entirety and then watch it at a later time. Such a model allows for viewing at the user's leisure. However, the movie is paid in full before the download may begin. Hence, if the user never views the movie, they have still paid for it. Further problems with this model are bandwidth limitations. Downloading a single movie can take 4-8 hours based on typical broadband speeds of between 1.5 Mbps-6 Mbps. Dialup modems, which still account for a large percentage of computer users, would be unable to download a typical movie in a reasonable time frame.

Although present rental models are functional, they are not sufficiently satisfactory. Accordingly, a system and method are needed to address the shortfalls of present rental models to provide other new and innovative features.

### SUMMARY OF THE INVENTION

Exemplary embodiments of the present invention that are shown in the drawings are summarized below. These and other embodiments are more fully described in the Detailed Description section. It is to be understood, however, that there is no intention to limit the invention to the forms described in this Summary of the Invention or in the Detailed Description. One skilled in the art can recognize that there are numerous modifications, equivalents and alternative constructions that fall within the spirit and scope of the invention as expressed in the claims.

The present invention can provide a system and method for providing media content to a content subscriber. In one exemplary embodiment, the present invention can include a media device for controlling access to media content. The media apparatus may comprise a processor, a memory and a storage device housing to may house a storage device. The media apparatus also comprises a media database that stores information about media content residing on the storage device. The media apparatus may also comprise one or more communication interfaces for communicating with a content provider, the storage device or other devices. The media apparatus may also include a real-time clock to maintain the current time and date. Further, the media apparatus may comprise a viewing policy engine for controlling access to the media content on the storage device.

Additionally, the media apparatus may include a viewing policy engine for controlling access to the media content on the storage device. The media apparatus may also exist as a portable media player through the inclusion of a display, a speaker, an input device and audio and video outputs.

The viewing policy engine may further comprise individual modules responsible for management of differing responsibilities. The viewing policy engine may comprise a content management module for managing the media content stored on the storage device. The content management module may further monitor which media content has been viewed from the storage device. A pre-release management module may also exist for the management of access to media content based on a release date of the media content, wherein access to the media content is denied while the media content's release date is less than a current date. The viewing policy engine may further comprise a content ownership module for managing access to media content wherein the media content is owned by a content subscriber.

Additionally, the viewing policy engine may comprise a subscription verification module for verifying a validity of a rental agreement associated with the media apparatus. A consumption policy module may also exist for enforcing a group of rules associated with a rental agreement type, wherein the rental agreement type is transaction-based or subscription-based. A parental control module may also exist for controlling access to media content based on an age rating of the media content. Lastly, a digital rights management module exists for enforcing digital rights associated with the media content.

Additionally, the present invention may also include a system for delivering media content to a user. The system may comprise a media apparatus. Additionally, a content provider exists to provide media content to the media apparatus. The content provider may further comprise a first data storage for storing subscription information associated with the media storage device. A second data storage also exists for storing media content. The content provider may also comprise a delivery module for providing the media content to the media apparatus device. Lastly, the content provider may also comprise a request module for receiving requests for media content from the user.

Additional aspects of the system may comprise automated kiosks able to provide content to the user. The kiosks may communicate with the content provide to retrieve additional media content. Rental stores may also exist providing similar functionality as the automated kiosks.

In another embodiment, the present invention may include a method for delivering media content to a content subscriber. The method begins by receiving a rental request from a content subscriber. The request may be for a digital media file. The media file is provides to the content subscriber, wherein the media file is stored on a media apparatus associated with the content subscriber. The media file is then flagged as rented only when the media file is viewed on the media apparatus. Further, the media file is applied to a rental agreement associated with the content subscriber when the first media file is flagged as rented.

As previously stated, the above-described embodiments and implementations are for illustration purposes only. Numerous other embodiments, implementations, and details of the invention are easily recognized by those of skill in the art from the following descriptions and claims.

### BRIEF DESCRIPTION OF THE DRAWINGS

Various objects and advantages and a more complete understanding of the present invention are apparent and more readily appreciated by reference to the following Detailed Description and to the appended claims when taken in conjunction with the accompanying Drawings wherein:

FIG. 1 is a system diagram illustrating an embodiment of a media disk and its components;

FIG. 2 is a system diagram illustrating one embodiment of a media player;

FIG. 3 is a block diagram illustrating an embodiment of a view policy engine and its software components;

FIG. 4 is a flow diagram illustrating the processing steps involved in one embodiment of a content management module;

FIG. 5 is a flow diagram illustrating the processing steps involved in one embodiment of a pre-release management module;

FIG. 6 is a flow diagram illustrating the processing steps involved in one embodiment of a content ownership module;

FIG. 7 is a flow diagram illustrating the processing steps involved in one embodiment of a subscription verification module;

FIGS. 8A and 8B are flow diagrams illustrating the processing steps involved in one embodiment of a consumption policy module;

FIGS. 9A and 9B are flow diagrams illustrating the processing steps involved in one embodiment of a parental control module;

FIG. 10 is a block diagram illustrating an embodiment one embodiment of a media content delivery system;

FIG. 11 is a block diagram illustrating another embodiment of an expanded media content delivery system;

FIG. 12 is a flow diagram illustrating one embodiment of a method for requesting and receiving media content from a content provider; and

FIG. 13 is a flow diagram illustrating one embodiment of a rental agreement engine enforcing a rental agreement with a media disk.

### DETAILED DESCRIPTION

### The Media Disk

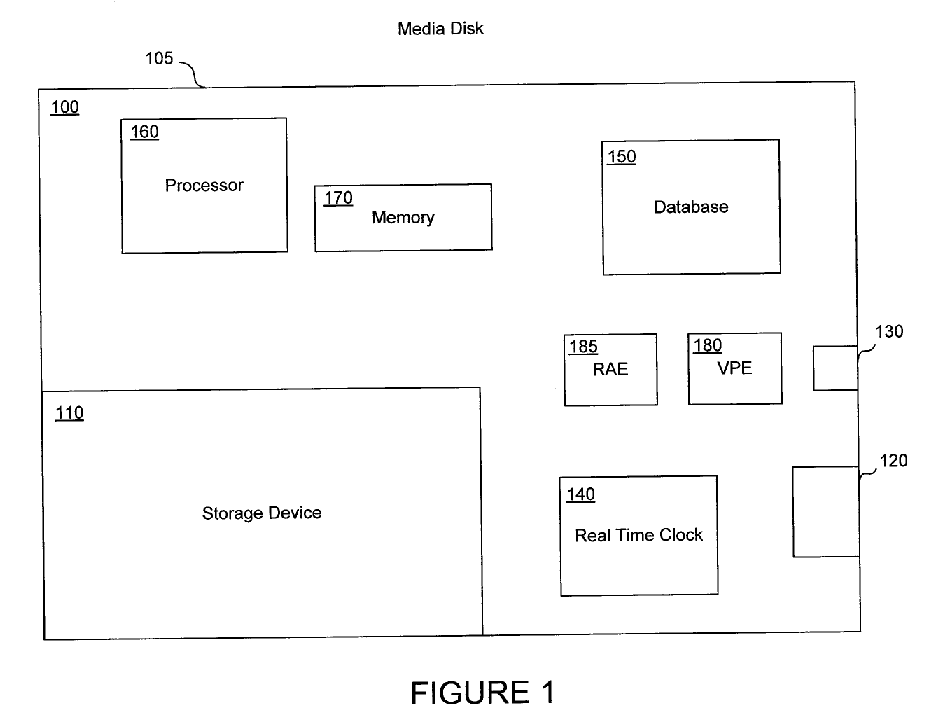

Referring now to the drawings, where like or similar elements are designated with identical reference numerals throughout the several views, and referring in particular to FIG. 1, which illustrates one embodiment of a media disk for providing media content to a user. A media disk 100 is able to store and play media content on external audio/visual equipment such as a laptop, television, home theater equipment, portable media players, and other set top boxes (e.g., DVR, Sling box, cable box, satellite box) via a standard (e.g., USB, Firewire, etc.) or a proprietary interface. Using the media disk 100, a content subscriber may access a selection of media content from a content provider. The subscriber may choose a plethora of content to be downloaded onto a media disk 100. The media disk 100 (including the chosen content) may then be mailed to the content subscriber. Such an approach permits the content subscriber to watch the content at their leisure. Further, rental fees for the content incur only at the time of playback and neither at the time of ordering the content nor at the time of receipt of the content.

The media disk 100 consists of an enclosure 105 for housing all the components comprising the media disk 100. Within the enclosure 105 is a storage device 110. The storage device 110 may be a hard drive, flash memory or other storage medium known in the art. In one embodiment, the storage device 110 is a hard drive with a storage capacity between 100 GB (gigabyte)-1TB (terabyte). This may allow for the storage of between 66-660 movies (based on a typical 100 minute movie) in standard definition encoded at 2 Mbps and fewer movies for content that was encoded at higher bit rates or resolution (e.g., high definition). In one embodiment, the storage device 110 may also be removable and interchangeable amongst other media disks. In yet another embodiment, the media disk 100 may comprise more than one storage device for additional storage capacity.

The media disk 100 also has one or more communication ports 120 for communication with a computer, media player, routing device or other devices. The communication port 120 may be, but are not limited to, Ethernet, USB, Firewire, SATA, eSATA, SAS, Fibre Channel, or a proprietary connector. In one embodiment, the media disk 100 may comprise an Ethernet port and a USB port, permitting connection of the media disk 100 to both a computer's USB and Ethernet ports or to a local area network (“LAN”).

Media disk 100 may also have a power plug and adapter 130, permitting the unit to receive electrical power from a standard 110/220 volt electrical socket. In another embodiment, the media disk 100 may have a rechargeable battery. Further, the media disk 110 may draw power over another interface such as USB, Ethernet, or other standard or proprietary connectors or interfaces.

The media disk 100 may also have a real-time clock 140. The clock 140 permits the media disk 100 to calculate a number of time and date based calculations regarding the viewing period of media content. The clock 140 may be implemented in hardware, firmware, software or any combination thereof.

The media disk 100 may also include a media database 150 for maintaining information relating to the content stored on the media disk 100. In one embodiment, the media database 150 may reside on the storage device 110. In another embodiment, the media database 150 may reside in a memory 170. For redundancy, the media database 150 may also reside in both the storage device 100 and the memory 170. In yet another embodiment, the media database 150 may not reside on the media disk 100, but rather be available via the Internet by a media content provider. Address this in regards to media player since player is unknown at this point in spec.

The media disk 100 may also have a processor 160 and a memory 170. The processor 160 may be responsible for decoding audio and video content being played by the media disk 100. The memory 170 may be volatile or non-volatile memory responsible for hosting an operating system, BIOS, other software or firmware, or file system components utilized by the media disk 100.

The media disk 100 may also incorporate additional mechanisms for protection of the disk against both physical and security damage. Firstly, the media disk 100 may incorporate anti-tampering mechanisms such as proprietary or security screws preventing one from physically opening the disk. In another embodiment, an electronic or mechanical device (not shown) may be used to detect opening of the disk enclosure 105. Second, the media disk 100 may incorporate shock protection mechanisms to protect the storage device 110 and other components in the event the media disk 100 is dropped. Any anti-shock mechanism currently known in the art may be implemented without limiting the scope of the invention. Third, the media disk 100 may implement encryption capabilities in regards to both the media content stored on the storage device 110 and the media database 150. Traditional encryption and decryption mechanisms currently know in the art may be used without limiting the scope of the invention. Four, password protection may also be implemented before access to the media content stored in the storage device 110 is granted. Lastly, a secure boot loader may also be implemented, preventing unauthorized access to the media disk during its boot-up sequence.

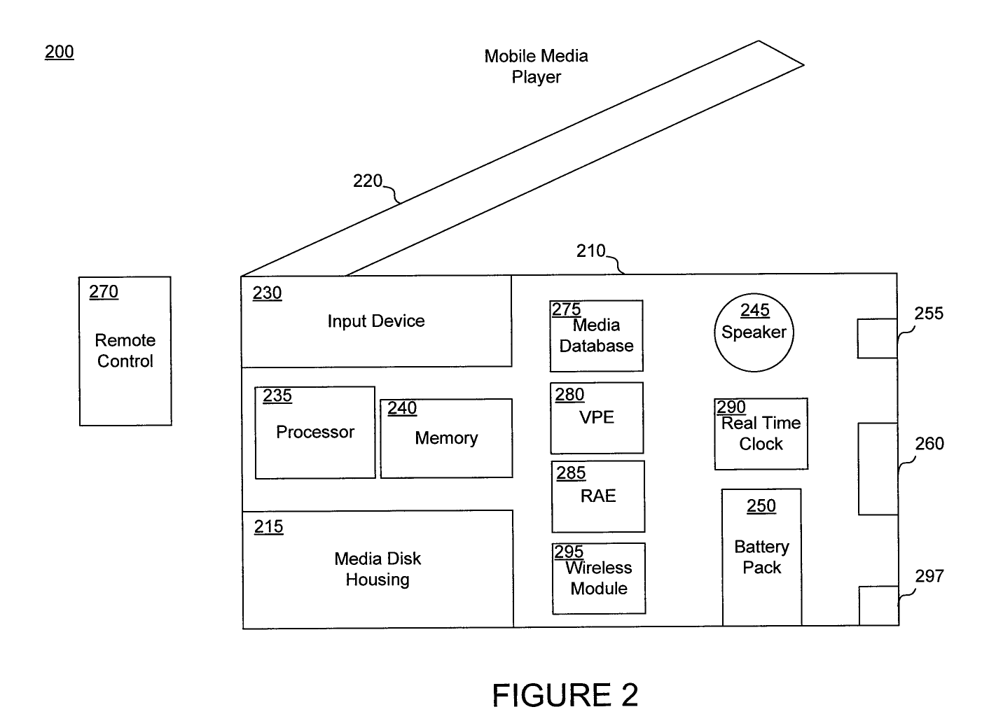

In yet another embodiment, the media disk 100 may also have a Subscription Policy Engine 180 and a Rental Agreement Engine 185. These engines may enforce certain policies associated with the media disk 100. These engines will be described in greater detail in regards to FIG. 2.

The functionality of a media disk 100 may also be incorporated into existing third party media devices such as Blackberry™, iPhone™, iPod™, Zune™, and other media capable phones or devices.

The list of components as described in relation to the media disk 100 is not meant to be inclusive. Additional hardware and software components may be attached to the media disk 100 without detracting from the scope of the invention. Further, one or more of the described components may be removed without limiting the scope of the invention.

### Media Player

FIG. 2 illustrates a system diagram of one embodiment of a media player. A media player 200 is an optional portable device capable of reproducing, and optionally displaying the audio and video of media content stored on a media disk 100. In one embodiment, a media player 200 may be purchased or rented from a content provider. The media player 200 consists of an enclosure 210 for housing all the components comprising the media player 200. The media player 200 also has a media disk housing 215 which permits the media disk 100 to slide into the media disk housing 215. In another embodiment, the media player 200 may also have an additional interface (not shown) for connection to the media disk 100. The interface may be a standard interface (e.g., USB, Firewire, etc.) or a proprietary interface. Once connected, the media player 200 is capable of accessing the media content stored in the media disk 100.

The media player 200 also may comprise a processor 235 and a memory 240 providing similar functionality as the processor and memory provided in the media disk 100. In order to provide wireless power to the media player 200, a battery pack 250 may be available. This permits the media player 200 to be played in a situation where hard connected wires are impractical. The battery pack 250 may be recharged by plugging an AC or DC plug 255 into the media player 200. In one embodiment, the attachment of the plug 255 may simultaneously provide power to the media player 200 for immediate playback as well as charging of the battery pack 250.

In another embodiment, the media player 200 may also be a mobile media player allowing for reproduction of the media content directly on the player. In such an embodiment, the mobile media player also comprises a display 220 for visual playback of the media content. In one embodiment, the display is an LCD screen with a diagonal size of between 8 and 15 inches. The mobile media player may also comprise one or more speakers 245 or audio headphone jacks (not shown) for reproducing the audio associated with media content.

In addition to audio and visual playback of media content on the media player itself 200, external A/V equipment may also be used through the inclusion of audio visual (“A/V”) outputs 260. The A/V outputs 260 may provide for both digital and analog connections to many types of external A/V equipment such as audio receivers, audio pre-amplifiers/processors, television displays, projectors, DVRs, set top boxes and computers, etc.

If the content is a computing or console game, A/V outputs 260 may be used to connect the media disk 100 to a computer, gaming console (e.g., Microsoft's Xbox™ series, Sony's Playstation™ series or Nintendo's Wii™) or a portable gaming console (e.g., Nintendo's Gameboy™ or Sony's PSP™, etc.).

Input devices are also helpful for user control of the media player 200. Input device 230 may be attached to the media player 200, allowing a user to input commands. Input device 230 may be a keyboard, touch-pad or other pointing device often found on laptop computers. Alternatively, input 230 may consist of a series of buttons such as those found on portable MP3 players. A remote control 270 may also provide input functionality to media player 200 without requiring physical manipulation of the input device 230. The remote control 270 may be infrared, radio frequency or other wireless protocols. Further, media player 200 may also have a wireless interface for receiving commands from the remote control 270. In another embodiment, the display 220 may be a touch screen allowing a user to input commands to media player 200.

As with the media device 100, the media player 200 may also have a media database 275, providing the same functionality as in the media disk 100. Further, the media database 275 may be stored in the memory 240 or an optional storage device (not shown). An advantage of having a media database stored in both the media disk 100 and the media player 200 is for redundancy back-up. For example, if the media disk 100 were to be lost, stolen or damaged beyond repair, a second copy of the database is available on the media player 200. Hence, when a replacement media disk is received, it may be connected to the media player 200, permitting download of the media database to the media disk. Further, the opposite scenario may occur wherein the media player is lost, destroyed or damaged. Hence, a replacement media player may download the media database from the media disk 100. Lastly, the media content provider may also maintain a copy of the media database, such that a download of the database to or from the provider via the Internet is possible.

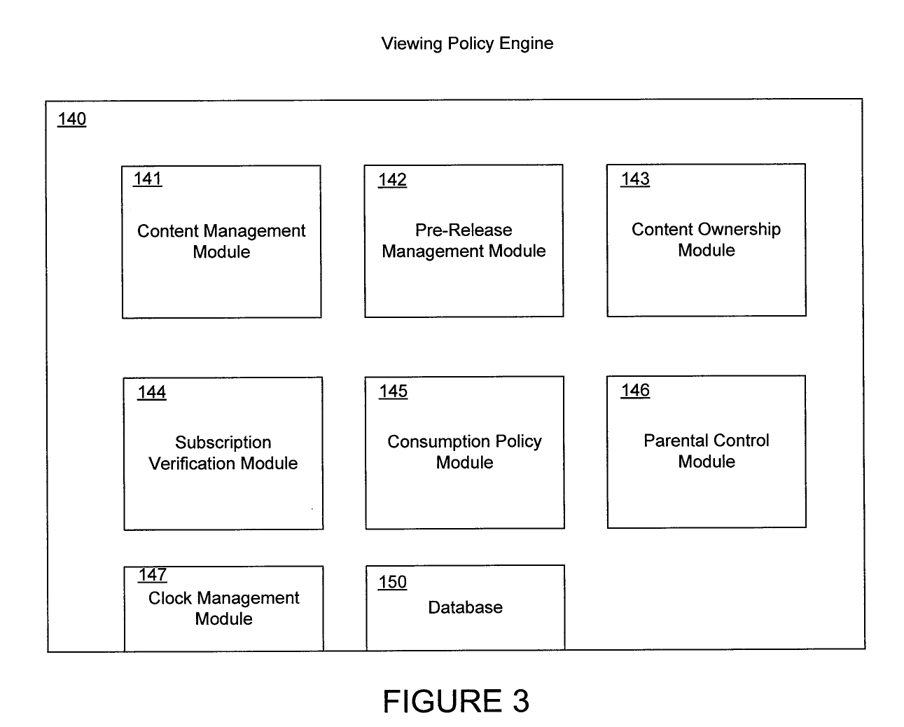

In one embodiment, the media player 200 further includes a viewing policy engine (“VPE”) 280. The VPE 280 is responsible for enforcing policies regarding the media content contained in the media disk 100. The VPE 280 may be comprised of hardware, software or firmware or any combination thereof. Further details of the viewing policy engine 280 are described in FIGS. 3-9.

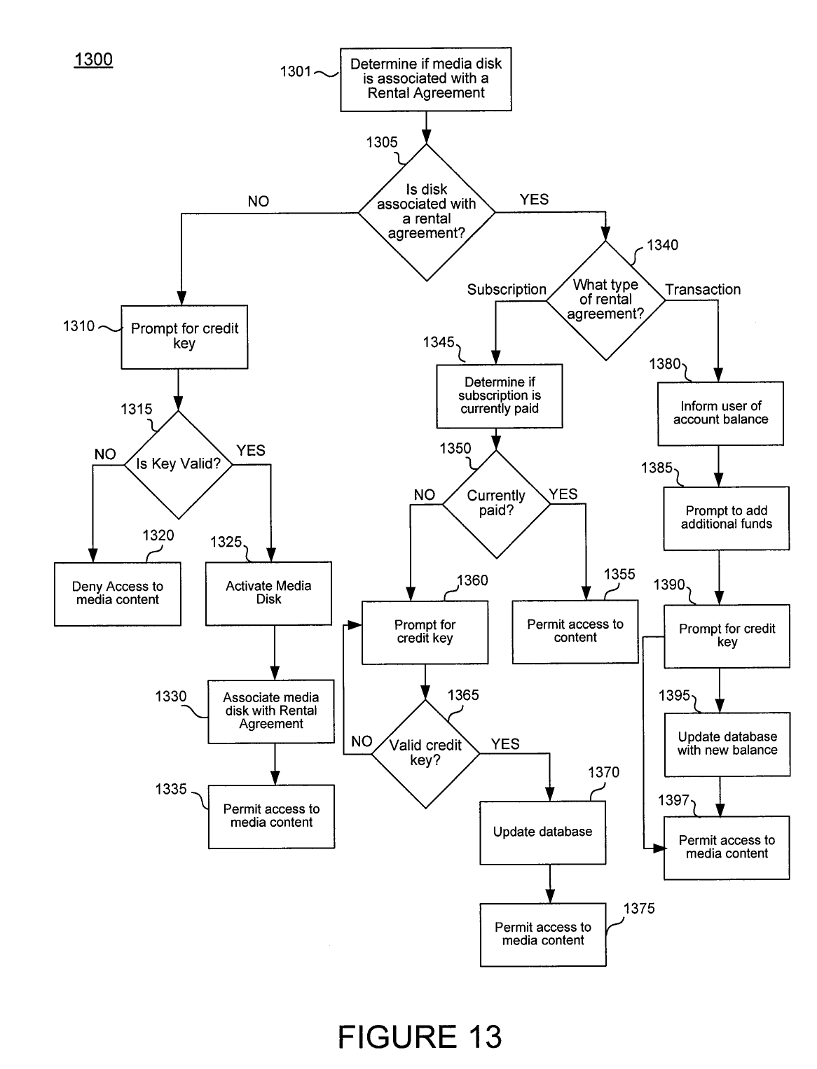

In another embodiment, the media player 200 may also include a rental agreement engine (“RAE”) 285. The RAE 285 is responsible for enforcing policies regarding the rental agreement associated with the media disk 100. The RAE 285 may be comprised of hardware, software or firmware or any combination thereof. Further details of the RAE 285 are described in FIG. 13.

As with the media disk 100, the media player 200 may also include a real-time clock 990, providing similar functionality as the clock 140 in the media disk 100.

The media player 200 may also have both wired and wireless interfaces to other devices such as computers, routing device, etc. Wireless communication module 295 permits communication with other devices through protocols such as, but not limited to, 802.11a, b, g, and n and Bluetooth. Communication interface 297 may also provide for wired communication to additional devices. Interface 297 may include a standard interface (e.g., USB, Firewire, Ethernet, etc.) or a proprietary interface.

Further, the media player 200 may also include tamper resistant capabilities such as those described in regards to the media disk 100. The media player 200 may also include password protection for media access such as described in relation to the media disk 100. Lastly, the media player 200 may also implement secure boot loader mechanisms such as described in regards to the media disk 100.

The above-described attributes of the media player 200 are meant as examples only. Additional attributes may be included such as wireless communication, optical drives, etc. Further, existing attributes may be deleted from the media player 200 without limiting the scope of the invention.

### The Viewing Policy Engine

FIG. 3 illustrates an embodiment of a viewing policy engine (“VPE”). In one embodiment, the VPE 140 is responsible for enforcing rules based on the subscriber rental agreement, the subscriber themselves, and the content provider. In one embodiment, the VPE 140 comprises seven functional modules named: content management module 141; pre-release management module 142; content ownership module 143; subscription verification module 144; consumption policy module 145; parental control module 146; and clock management module 147. In another embodiment, there may also be a Digital Rights Management (“DRM”) module (not shown). Any of the DRM technologies known in the art may be used without limiting the scope of the invention. In order for a content subscriber to gain access to media content stored on a media disk 100, each of the modules determine whether access is appropriate based on their areas of concern. In one embodiment, the VPE 140 and its individual modules are embedded in software, hardware, firmware or a combination thereof. In yet another embodiment, the VPE 140 may also utilize the media database 275 or 150 for storing information related to managing the content stored on the media disk 100. In order to maintain simplicity, reference to the media database 150 stored on the media disk 100 may also encompass the media disk 275 stored on the media player 200.

The first of the modules is the content management module 141, which is responsible for the management of the media content present on the media disk 100. As content is added or deleted, module 141 keeps track of such actions through updates to the media database 150. The media database 150 may keep track of all content ever added to the media disk 100 (whether the content still exists or not), when the content was added or deleted, whether the content was ever viewed and on what date, how many times content has been viewed, etc. Hence, module 141 is responsible for maintaining portions of the media database 150 depending on the actions taken regarding the content on the media disk 100.

The pre-release module 142 is responsible for enforcing rules with pre-released content. In one embodiment, media content that has not been released to the public for personal use may be downloaded to the media disk 100 before its release date. For example, a movie's release date on DVD may be July 4th. A content provider may permit the downloading of this movie before its release date. However, module 142 would prevent the viewing of the movie until the current date reaches July 4th. Such information may be stored in the media database 150. Therefore, whenever a content subscriber requests content, module 142 queries the media database 150 to verify that the content's release date is less than or equal to the current date.

The content ownership module 143 is responsible for managing content that is owned by a content subscriber. For example, certain content may have been purchased from the content provider, providing unlimited viewings of the content. Additionally, the content subscriber may add external content (i.e., content not purchased through the content provider) to media disk 100 from other sources such as a computer, etc. Such content may be flagged in the media database 150 as “owned”. Therefore, no rental policy is associated with the content. Module 143 may also enforce that “owned” content not be deleted from the media disk 100 unless explicitly requested by the content subscriber. Additionally, module 143 may permit the transfer of “owned” content from the media disk 100 to other mediums such as DVD, external hard drive, flash memory, or other media disks, etc.

The subscription verification module 144 is responsible for authenticating a rental agreement associated with a content subscriber. If a content subscriber wishes to access a movie stored on the media disk 100, the subscription verification module would verify that the subscriber has a valid subscription before permitting access to the desired content. For example, each time a content subscriber wishes to perform an action with the media disk 100, module 144 may authenticate that the content subscriber's rental agreement is valid and/or not in default for payment. If authentication is successful, the actions by the content subscriber are permitted. In one embodiment, this information is stored in the media database 150.

The consumption policy module 145 is responsible for enforcing rules based on the rental agreement type associated with a content subscriber. The differing types of rental agreements are described in more detail below. For example, if a content subscriber's rental agreement is subscription-based, module 145 keeps track of the number of rental permitted each month and the number of rentals already rented in the month. Upon a content subscriber's request to rent a movie, module 145 would verify whether additional rentals are available during the remainder of the month. In another example, if a content subscriber's rental agreement was transaction-based, module 145 may keep track of the remaining account balance and whether there are available funds for rentals. If a content subscriber's account balance is below a level sufficient to cover the cost of the rental, module 145 would deny access to the rental. Further, module 145 may also be responsible for adding or deleting funds from the account balance based on actions taken that would cause a change in the balance (i.e., movie rental, deposit of funds into the account from a credit card transaction, etc.).

Parental control module 146 is responsible for enforcing rules based on the age rating of media content such as movies, music or computing games. Such enforcement can be automatic or editable by the content subscriber in possession of the media disk 100. Hence, a content subscriber may set up rules permitting certain types of content to be viewed by anyone (i.e., G or PG rated movies). Additionally, the content subscriber may require that certain types of content may only be viewed upon entry of a password. For example, any movies rated NC-17 or R may require a subscriber-selected password to be entered. Module 146 maintains the age rating information of media content in the media database 150. When content is requested for rental, module 146 queries the media database 150 and determines whether the content would require a password to access the content. Additionally, the content subscriber may disable the need for password authentication for one or more levels of movie ratings. Further, permissions may be grouped by other criterion such as by viewer such that only the associated user may view certain content unless a password is entered.

Lastly, the clock management module 147 is responsible for reading the timestamp information provided by the real-time clock 290. Such information may be stored in the media database 150 in regards to media content viewing patterns.

In addition to the VPE residing on a media disk 100 or a media player 200, the VPE (and additionally the RAE) may also reside in software downloadable to a third party device capable of playing the media content residing on a media disk 100. In other words, a media player 200 is not the only device capable of playing the content on a media disk 100. Other devices such as set top boxes, DVRS, computers, etc. may be connected to a media disk 100. In order to enforce the rental agreement and viewing policy associated with the media disk 100, the VPE and RAE may be installed onto a playback device. Once installed, the playback device may provide the functionality of a media player 200.

In yet another embodiment, the VPE and RAE may also reside remotely over the Internet such that locally installed software is not required. The VPE and RAE may exist as a web service hosted by the content provider or other servicer.

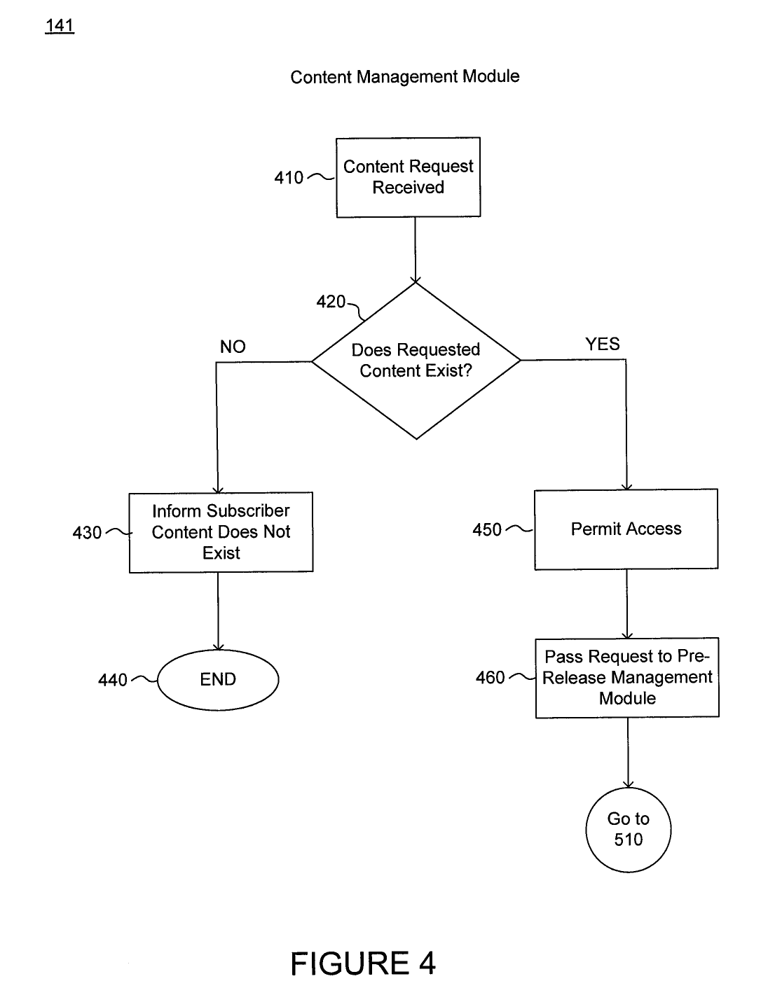

FIG. 4 is a flow diagram illustrating the processing steps undertaken by one embodiment of a content management module when a request for access to media content is made. When content is requested by a user of the media disk 100, the request is passed to the content management module 141. First, the request is received (step 410) by module 141. Module 141 queries the media database 150 to determine if the requested content exists on the storage device 110 of the media disk 100. A determination is made as to whether the requested content exists (step 420). If the content does not exist, module 141 informs the user that the requested content does not exist (step 430) and the request ends (step 440). However, if the requested content does exist, access to the content is permitted (step 450) by module 141. Lastly, the request is passed (step 460) to the pre-release management module 142.

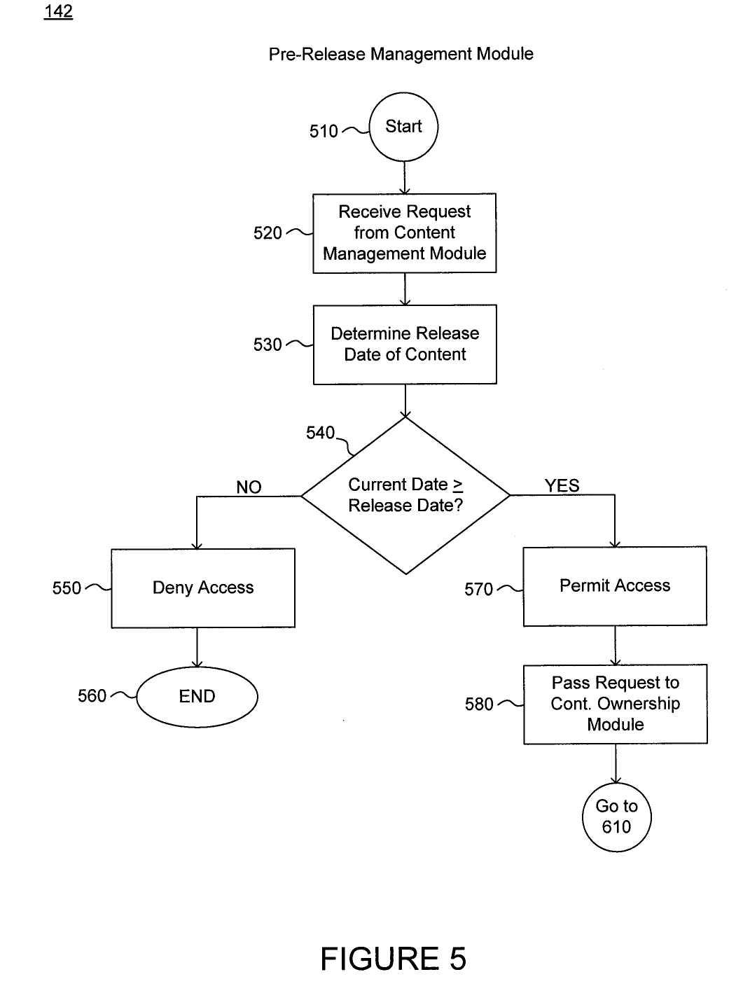

FIG. 5 is a flow diagram illustrating the processing steps undertaken by one embodiment of a pre-release management module when a request for access to media content is made. If access is permitted by the content management module 141, then the pre-release management module 142 starts (510) and receives the request (step 520). Next, module 142 queries the media database 150 to determine the release date of the requested content (step 530). A determination is made as to whether the current date is greater than or equal to the release date of the requested content (step 540). The real-time clock 290 or 140 is accessed in order to make such date and time determinations. If the current date is less than the release date, then access to the content is denied and a message is passed to the user indicating the same (step 550) and the request ends (step 560). However, if the current date is greater than or equal to the release date, then access is permitted (step 570) by module 142. Lastly, the request is passed (step 580) to the content ownership module 143.

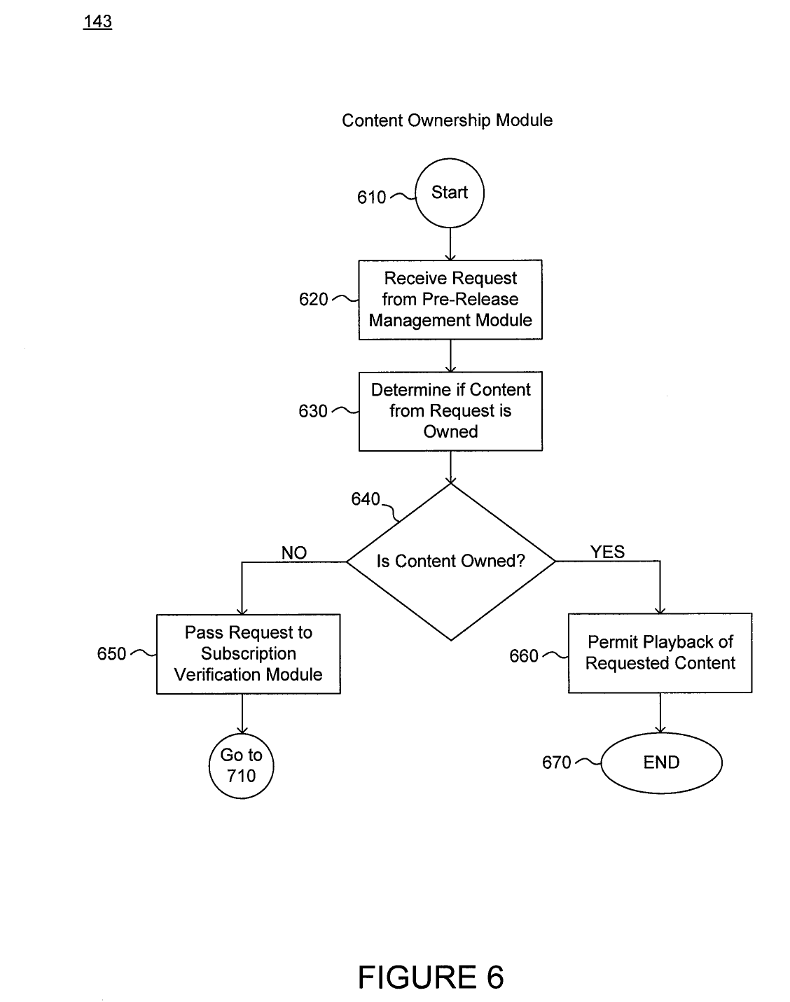

FIG. 6 is a flow diagram illustrating the processing steps undertaken by one embodiment of a content ownership module when a request for access to media content is made. If access is permitted by the pre-release management module 142, then the content management module 143 starts (step 610) and receives the request (step 620). Next, the media database 150 is queried to determine if the requested content is owned (step 630) by the subscriber associated with the media disk 100. Next, a determination is made as to whether the requested content is owned (step 640). If the content is not owned, then the request is passed (step 650) to the subscription verification module 144. However, if the content is owned, playback of the requested content is permitted (step 660) and the request ends (step 670).

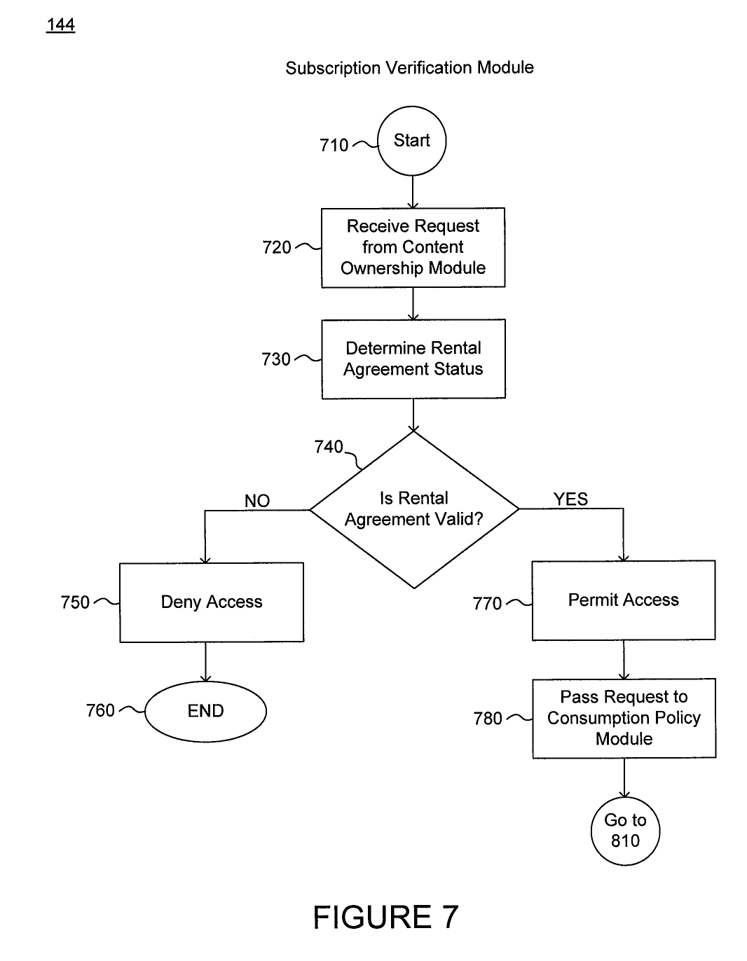

FIG. 7 is a flow diagram illustrating the processing steps undertaken by one embodiment of a subscription verification module when a request for access to media content is made. If access is permitted by the content ownership module 143, then the subscription verification module 144 starts (step 710) and receives the request (step 720). Next, the media database 150 is queried to determine whether the rental agreement associated with the media disk 100 is valid (step 730). In one embodiment, validation may be defined by whether 1) the rental agreement is still active; and 2) the account balance is not in arrears. However, other verifications may be used to determine whether a rental agreement is valid. Next, a determination is made as to whether the rental agreement associated with the media disk 100 is valid (step 740). If the rental agreement is not valid, then access to the requested material is denied and a message is passed to the user indicating the same (step 750) and the request ends (step 760). Additionally, an offer may be presented to re-open a subscription (not shown). However, if the rental agreement is valid, then access is permitted (step 770) by module 144. Lastly, the request is passed (step 780) to the consumption policy module 145.

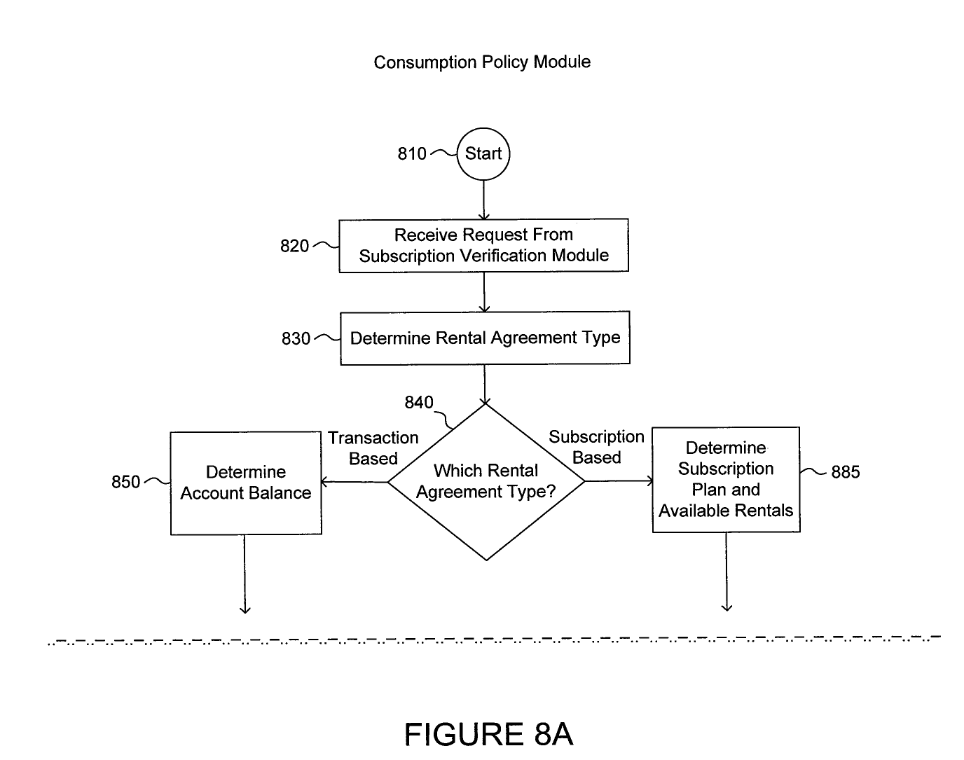

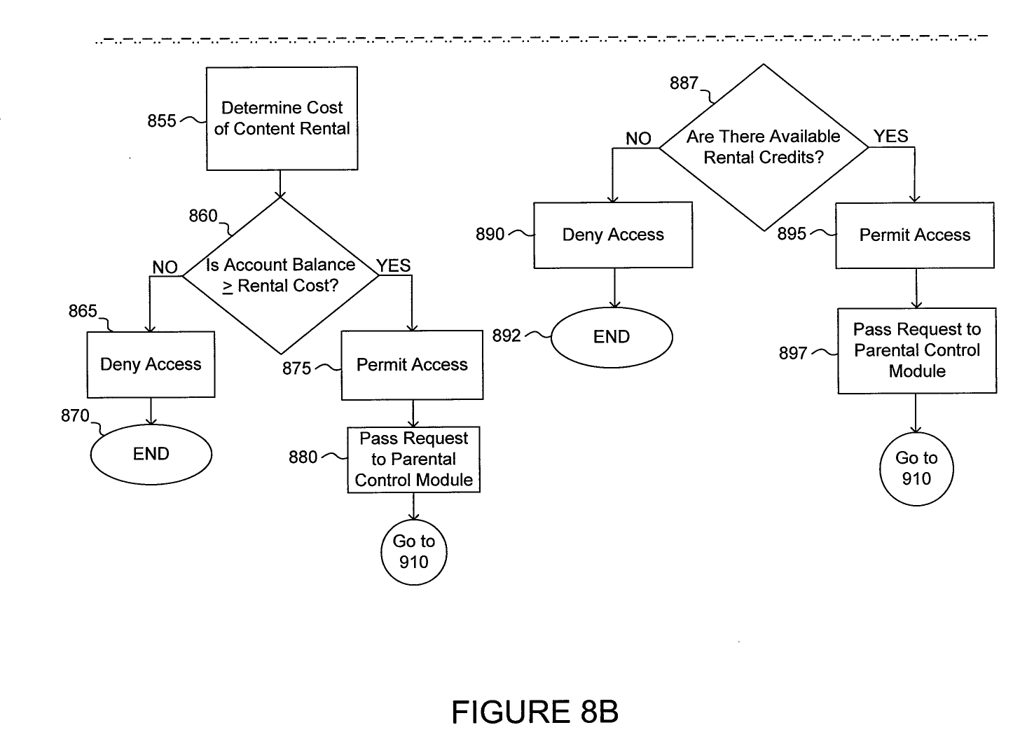

FIG. 8 is a flow diagram illustrating the processing steps undertaken by one embodiment of a consumption policy module 145 when a request for access to media content is made. If access is permitted by the subscription verification module 144, then the consumption policy module 145 starts (step 810) and receives the request (step 820). Next, the media database 150 is queried to determine the type of rental agreement associated with the media disk 100 (step 830). A decision is made based on the type of rental agreement (step 840).

If the rental agreement type is transaction-based, then the media database 150 is further queried to determine the account balance (step 850). Next, a determination is made as to the cost of the media content requested for rental (step 855). In the next step, a determination is made as to whether the account balance is greater than or equal to the rental charge of the requested content (step 860). If the current balance is less than the rental charge for the requested content, then access is denied (step 865) and the request ends (step 870). In another embodiment, the user may be permitted to add funds to their account, permitting access to the content upon the additional funds being recognized. However, if the account balance is greater than or equal to the rental charge of the requested content, then access to the content is permitted (875) by module 145. Lastly, the request is passed (step 880) to the parental control module 146.

On the other hand, if the rental agreement type is subscription-based, then the media database 150 is queried to determine the subscription plan and the number of available rentals (step 885). In one embodiment, a subscription plan would determine the numbers of rentals available per period of time. For example, one plan might allow eight rentals per month for $12.99/month. A different plan may allow four rentals a month for a cost of $7.99/month. Next, a determination is made as to whether the subscription has any available rentals for the remaining subscription period (step 887). If there are no remaining rentals for the subscription period, then access is denied and a message is passed to the user indicating the same (step 890). In another embodiment, the user is permitted to increase the viewing level of their subscription agreement (not shown). Lastly, the request ends (step 892). However, if there are remaining rentals for the subscription period, access is permitted (step 895) by module 145 and the request is passed (step 897) to parental control module 146.

In yet another embodiment, a user may subscribe to an unlimited subscription agreement wherein no restrictions to the amount of content viewed within the rental period.

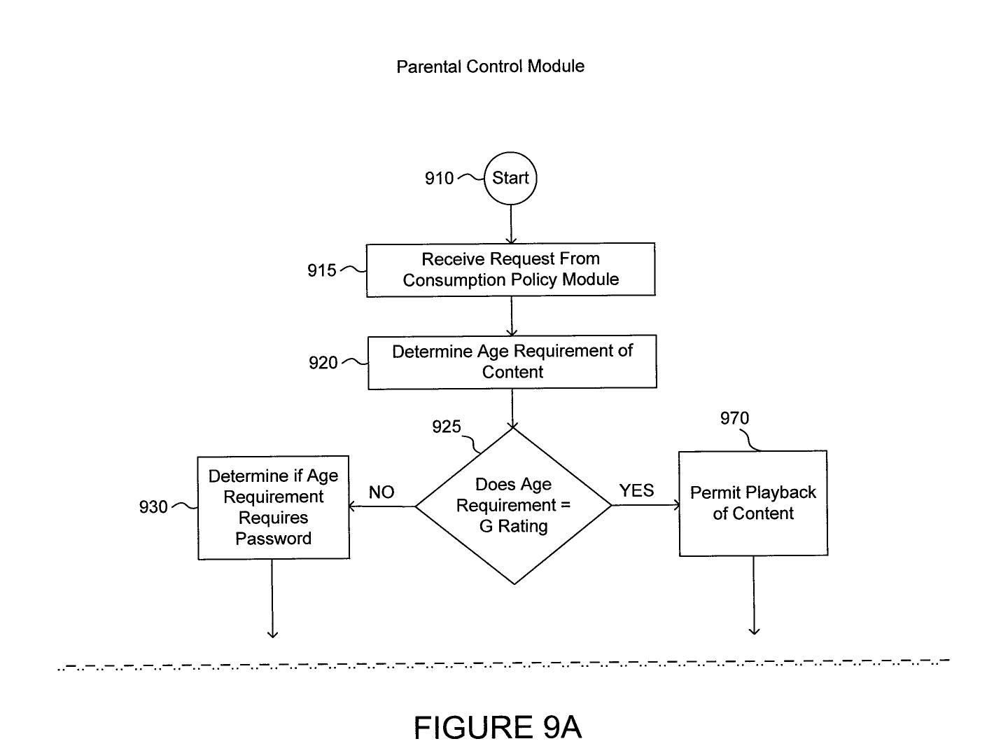

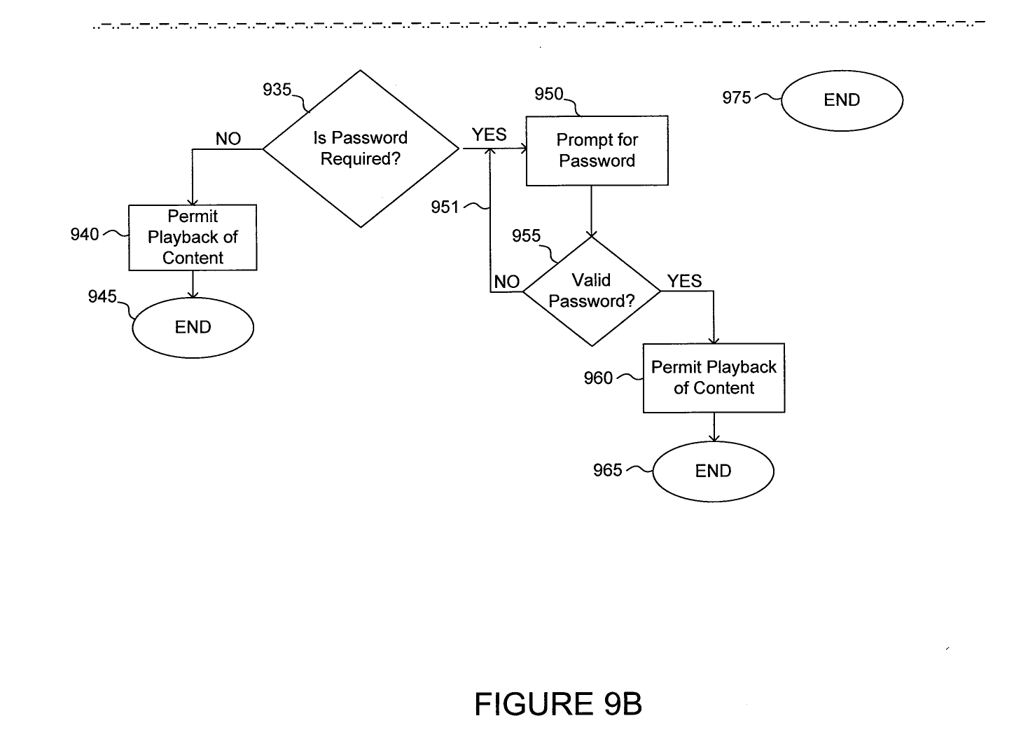

FIG. 9 is a flow diagram illustrating the processing steps undertaken by one embodiment of a parental control module 146 when a request for access to media content is made. If access is permitted by the consumption policy module 145, then the parental control module 146 starts (step 910) and receives the request (step 915). Next, the media database 150 is queried to determine the age requirement of the requested content (step 920). In one embodiment, each piece of media content is associated with an age requirement rating. For example, movies may use the MPAA rating system of G, PG, PG13, R, NC17 and XXX. Music, television, and games may use similar rating systems. Next, a determination is made whether the age requirement of the content is equal to “G” or its equivalent (step 925). If the age rating is equal to “G”, then playback of the requested content is permitted (step 970) by module 146 and the request ends (step 975).

In another embodiment, content may be associated with specific viewers of a media disk. For example, all of viewer A's content may expect a password to view, whereas viewer B's content may not expect a password and some of C's content may expect a password based upon differening criteria such as the MPAA rating.

However, if the age rating does not equal “G”, then the media database 150 is again queried to determine whether the age rating of the requested content requires a password for access (step 930). Next, the determination is made (step 935). If the age rating does not require a password, playback of the requested content is permitted (step 940) by module 146 and the request ends (step 945). However, if a password is required for the age rating, a password prompt is passed to the user (step 950). Module 146 then receives the password and checks whether it is valid (step 955). If the password is not valid, a password prompt is again passed to the user (step 955). In one embodiment, the number of password attempts may be set to a limit. If that limit is reached, the content may be forbidden playback until the password is reset or a pre-determined period of time has elapsed. If the password entered is valid, playback of the requested content is permitted (step 960) by module 146 and the request ends (step 965).

Once the playback of the requested content begins, additional functionalities of the viewing policy engine modules may occur. For example, when playback of the requested content begins, some of the modules may perform additional steps. In this example, the content management module 141 may update the media database 150 with a timestamp of when playback of the content began. Additionally, the consumption policy module 145 may update the media database depending on what rental agreement type is associated with the media disk 100. If the rental agreement is subscription-based, then the database 150 is updated to decrement the number of rentals remaining in subscription period. If the rental agreement is transaction-based, then the database 150 is updated to reflect the account balance as being reduced by the amount of the content's rental charge.

In yet another embodiment, a free viewing period may be permitted for some or all media content. For example, the viewing policy engine may allow for a pre-determined period of time for a user to view content without incurring rental charges until the free viewing period ends. Further, a message may be passed to the user that the free viewing period has ended and to confirm continuation which would result in a rental being recorded. If the user does not continue, then additional viewing of the content is denied and a rental is not recorded.

The above described modules associated with the viewing policy engine 140 are merely examples and not meant to limit the scope of the invention. The functionality described may be applied to a larger or smaller number of modules. Hence, in another embodiment, the functionality of the seven modules may be combined into a smaller number of modules. In yet another embodiment, the functionality of the seven modules may be distributed between a larger number of modules. Lastly, the ordering of the modules may be changed as well.

In the above descriptions, the functional processing steps of each module occur in a serial fashion (e.g., one module completes its steps before the next module begins.) In another embodiment, the modules may begin processing in parallel such that each module may begin without regard to the other modules.

### Receiving Media Content onto a Media Disk

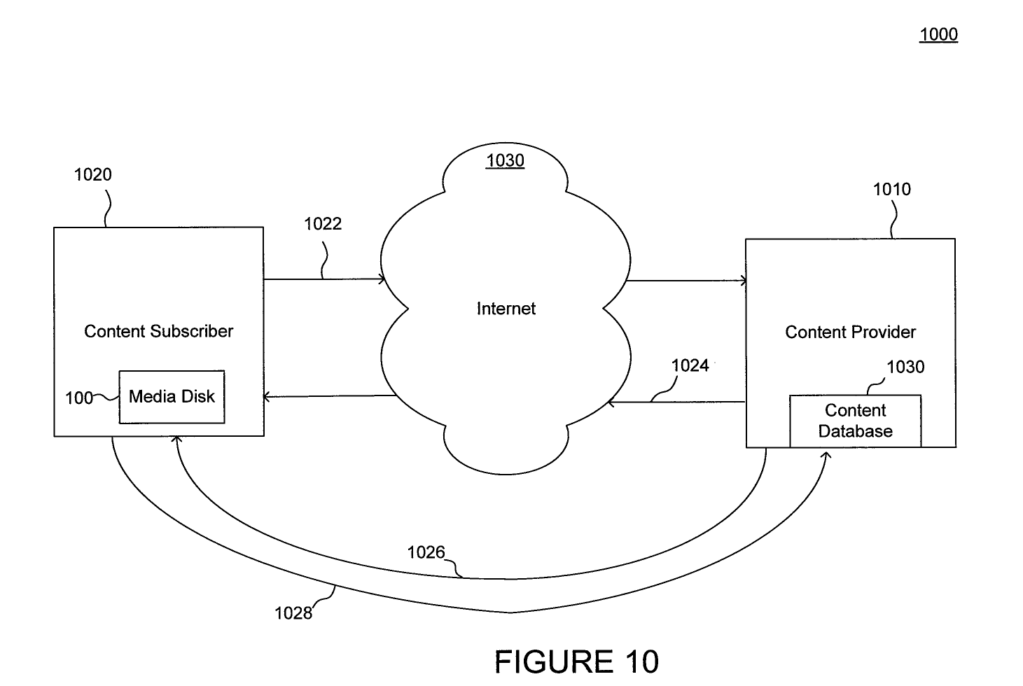

Differing mechanisms exist for delivering media content from one or more sources onto a media disk. FIG. 10 illustrates an embodiment of a media content delivery system 1000. The delivery system 1000 consists of a media content provider 1010 and a content subscriber 1020. The content subscriber 1020 signs up for a rental agreement associated with the content provider 1010. Under such a rental agreement, the content subscriber 1020 may receive and view media content from the content provider 1010. In one embodiment, the content subscriber 1020 is given a media disk 100 for storage and playback of media content provided by the content provider 1010. In one embodiment, the use of a media disk 100 is the preferred mechanism for providing media content to the content subscriber 1020.

In one embodiment, the content provider 1010 may have one or more content databases 1030 for storage of all the distributable media content. The media content available may include movies, television shows, documentaries, electronic books, commercials, music and electronic games. An advantage of this content delivery model lies in the pre-loading of media content to a media disk 100 without charging the content subscriber 1020 for a rental of the content unless and until the content is actually consumed (i.e., viewed for movies and electronic books, listened to for songs, played for electronic games). In other words, the content subscriber 1020 may request and receive a number of movies that are stored on the media disk 100. If the content subscriber 1020 does not view any of the movies, no rental charges incur. Whereas, if the content subscriber 1020 viewed two of the movies, only two rental charges are incurred. Such a rental policy allows the content subscriber 1020 to choose a plethora of media content for potential rental, without restriction to which content they wish to view and hence be charged for. Further, if the content selected by the content subscriber 1020 does not fill up the storage space of the media disk 100, the content provider 1010 may choose to fill the media disk 100 to capacity. The content provider 1010 may choose the type of content based on the content chosen by the content subscriber 1020. Hence, if the content subscriber 1020 selected mostly action movies, the content provider 1010 may add additional action movies in order to fill up the media disk 100 with content. Another advantage to this rental policy is the elimination of late fees as the VPE controls when content can be consumed.

As previously stated in regards to FIG. 8, there are multiple rental agreement types that may be associated with the media disk 100. As disclosed in FIG. 2, a rental agreement engine 190 (“RAE”) is an additional functional module implemented in the media player 200. RAE 285 is responsible for implementing and enforcing the type of rental agreements associated with the media disk 100. FIG. 13 is a flow diagram illustrating one embodiment of the RAE 285 enforcing a rental agreement associated with the media disk 100. In one embodiment, when the media disk 100 is plugged into a player (e.g., third party set top box, gaming console, computer, stand alone media player, etc.) or turned on (e.g., as part of the media player 200), the RAE 285 is involved in authentication and enforcement of a rental agreement in association with the media disk 100. In the instance when the front end device (e.g., third party set top box, gaming console, computer, stand alone media player, etc.) that displays the media content is not a media player provided by the content provider, the RAE 285 and VPE 280 may be downloaded to the front end device to enforce the rental agreement and viewing policy associated with the media disk 100. For example, if a user connects their media disk 100 to a laptop, the content (except for free, owned or downloaded content from other sources) contained in the disk is not viewable as there is no RAE 285 and VPE 280 established to enforce the policies. Therefore, a copy of the RAE 285 and VPE 280 associated with the media disk 100, may be downloaded to the laptop, permitting enforcement of the policies. Additional approaches may be used to place a copy of the RAE 285 and the VPE 280 on other front end devices as described above.

First, RAE 285 determines whether the media disk 100 is associated with a rental agreement (step 1301). This information may be stored in a database such as the media database 150. Hence, RAE 285 queries the media database 150, and a determination is made as to whether the media disk 100 is associated with a rental agreement (step 1305). If the media disk 100 is not associated with a rental agreement, then the user is prompted to enter a credit key (step 1310). As described in more detail below, a credit key may be an alphanumeric key generated by the content provider 1010. If a user signs up for a rental agreement through a website associated with the content provider 1010, the user will be supplied with a credit key. This key may be inserted into a media disk 100 to activate the media disk 100 and inform the media disk 100 of the rental agreement to be associated with the media disk 100. If the media disk 100 is connected to the media player, the credit key may be entered through the input device 230, a touch screen implemented in the display 220 or the remote control 270. Alternatively, if the media disk 100 is connected to a computer or other device, the credit key may be entered via a keyboard or other input device.

Next, a determination is made as to whether the credit key is valid (step 1315). If the entered credit key is invalid or if the user does not have a credit key, then access to the media disk is denied (step 1320). However, if the credit key is valid, then the media disk 100 is activated (step 1325). Next, the media database 150 may be updated to reflect the new rental agreement and its association to the media disk 100 (step 1330). Lastly, access to the media disk 100 is granted (step 1335).

Returning to step 1305, if the media disk 100 is associated with a rental agreement, then a determination is made as to which type of rental agreement is associated with the media disk 100 (step 1340). If the rental agreement is subscription-based, then the media database 150 is queried to see if the subscription is paid up to date (step 1345). A determination is made as to whether the subscription is paid up to date (step 1350). If the subscription is paid up to date, then access to the media content on the media disk 100 is granted (step 1355). However, if the subscription is not currently paid up, RAE 285 prompts for the content subscriber to enter a credit key to bring the account current (step 1360). If the entered credit key is invalid or if the content subscriber does not input a credit key, then the RAE 285 continues to prompt for a credit key, denying access to the media content until a valid key is entered. If a valid credit key is inserted then the media database 150 is updated to reflect this information (step 1370) and access to the media content is granted (step 1375).

Returning to step 1340, if the rental agreement type is transaction-based, then the RAE 285 may inform the content subscriber of their current account balance (step 1380) and prompt whether the content subscriber would like to add additional funds to the account (step 1385). If additional funds are to be added, then the RAE 285 prompts for a credit key (step 1390). If additional funds are not desired, then access to the media content is granted (step 1397). If a valid credit key is entered, the media database is updated to reflect the new account balance (step 1395) and access to the media content is granted (step 1397).

The above steps are merely an example of how the RAE 285 may enforce a rental agreement with the media disk 100. Other enforcement policies may be implemented without altering the scope of the invention. For example, access to a media disk 100 may exist regardless of a rental agreement being associated with the disk if free or promotional content exists. Such content may be considered viewable at will. Additionally, a media disk 100 may have content loaded onto it by a user from other sources such as the Internet, a computer, DVR, portable media players, owned content from other media disks, etc. Such content may be unmonitored by the RAE 285 and VPE 280 and hence viewable at will without the need for a valid or current rental agreement. Lastly, content may be purchased through the content provider 1010. Such content may also remain unmonitored by the RAE 285 and VPE 280.

In one embodiment, the RAE 285 is implemented in software, hardware, firmware or any combination thereof. In another embodiment, the RAE 285 may be part of the VPE 280. Alternatively, the RAE 285 may be an individual module as show in FIG. 2. In yet another embodiment, the functionality of the RAE 285 may be implemented into the VPE 280 and any of its individual modules.

As described in regards to FIG. 13 above, there are two primary rental models are described herein. However, additional rental models maybe used without limiting the scope of the invention. The first rental model is the subscription-based rental model. In such a model, the consumption policy module 145 permits the content subscriber 1020 to view a pre-determined number of rentals in a pre-determined period of time. For example, one subscription plan may provide for ten rentals per month for a cost of $15/month. Another plan may provide for unlimited rentals per month for a cost of $30/month. These are merely examples and not meant to limit the scope of the invention. In another embodiment, the consumption policy module 145 may adjust the subscription-based rental models based on the type of content which may be viewed. In one embodiment, the consumption policy module 145 may permit rental credits to be used to rent content. For example, one subscription model may provide for 10 rental credits per month. One rental credit may equate to one movie, three half hour television shows or two one hour television shows, etc. In other words, different types of content may have different rental values. In this example, if a ten rental credit per month subscription is associated with the media disk 100, then the consumption policy module 145 may allow for ten movie rentals, 30 half hour television shows, 20 one hour television shows or any combination thereof.

In another embodiment, the consumption policy module 145 may allow for further changes to the subscription's cost based on the rental period allowed for each content rented. In other words, a ten rental credits per month subscription may cost $15/month wherein the content may be viewed for 24 hours from the start of viewing of the content. Whereas the same subscription may have a different cost if the content may be viewed for 10, 30 or 90 days from when the content is initially viewed. Such an approach may permit content subscriber 1020 to watch a movie as many times as they wish during the viewing period. However, once the viewing period ends, the consumption policy module 145 may require additional rental credits to view the content again.

In another embodiment, another rental model is a transaction-based rental model. In such a model, the consumption policy module 145 does not charge monthly subscription fees to the content subscriber's 1020 account. In contrast, rental fees only incur upon the rental of content by the content subscriber 1020. The consumption policy module 145 may predetermine a cost to be associated with each type of media content. For example, a movie rental may have a cost of $4, a one hour television show may have a cost of $2 and a half hour television show may have a cost of $1.50. This model may allow the content subscriber 1020 to view as many or as little rentals per month as they wish without concern for a monthly subscription charge.

In yet another embodiment, the consumption policy module 145 may permit the use of rental credits in the transaction-based rental model. For example, a rental credit may cost the content subscriber 1020 $4. The rental credit may then be used to rent differing types of media content. For example, one rental credit may permit rental of one movie, two one hour television shows or three half hour television shows. In another embodiment, the consumption policy module 145 may permit the pre-purchase of rental credits in large quantities resulting in a reduced price per credit. For example, the rental subscriber 1020 may purchase 10 rental credits at a cost of $35, resulting in a per rental credit cost of $3.50 instead of the normal cost of $4.

In another embodiment, the consumption policy module 145 may also associate the cost of media content based on different viewing policies such as non-subsequent day rentals and numbered viewings. A non-subsequent day rental may be a rental of a movie where the viewing period may not be based on subsequent days. For example, a viewing period of three days may be separated into three consecutive Fridays. On the other hand, numbered viewings allow for a movie to be viewed a predetermined number of times over any time period. For example, a movie may be rented based on five viewings. Hence, the content may be viewed five different times over any period of time. In one embodiment, such rental information may be stored in the media database 150, permitting the consumption policy module 145 to query the database 150 when access to the content is desired. The consumption policy module 145 may then determine if the requested content may be viewed without additional fees.

Under the transaction-based rental model, the consumption policy module 145 may support the payment of rentals from at least two different payment formats. First, a deposit-based system may be used, wherein content may not be rented unless sufficient funds exist within the content subscriber's 1020 account. For example, if the content subscriber 1020 has $3 in their account and they wish to view content that incurs a cost of $4, additional funds are expected to permit viewing. The consumption policy module 145 may permit the addition of funds in a variety of methods. In one embodiment, the content subscriber 1020 may log on to a website associated with content provider 1010. Funds may be added to the account through credit card, bank draw or other payment systems such as Paypal™ or Google Checkout™. Once funds have been added to the account, the media disk's 100 media database 150 and/or the media player's 200 media database 275 may be updated to learn about these additional funds through a connection of the media disk 100 and/or the media player 275 to a computer or routing device connected to the Internet.

Once a connection is made, the content provider 1010 may transmit the necessary information to the media disk 100 and/or the media player 200 such that the account balance is updated within the media database 150 and/or 275. In another embodiment, upon the addition of funds to the content subscriber's 1020 account, a credit key may be supplied by the content provider 1010 through email, computer display, postal mail, telephone or other means. In one embodiment, the consumption policy module 145 may enforce the credit key as a string of alphanumeric characters. The content subscriber 1020 may then enter the credit key into the media disk 100. In one embodiment, the characters used to form the credit key may be coded in such a way that the amount of funds to be added are embedded into the key. The credit key may be input into the media disk 100 and/or the media player 200 by many means such as input device 230, remote control 270, an optional touch screen as part of the display 220, input device from a computer, etc.

In another embodiment, the consumption policy module 145 may permit the use of a key card in lieu of a credit key. A key card may be a physical card having a magnetic strip similar to strips found on credit cards. Additionally, the key card may be a smart card with embedded wireless technology for wireless transmission of information to the media disk 100 and/or the media player 200. A key card may have encrypted data signifying that an additional amount of money should be added to the content subscriber's 1020 account balance. Alternatively, the media disk 100 and/or the media player 200 may have a slot permitting a swipe of the key card which is then read. Upon entry of the credit key or key card, the consumption policy module 145 updates the account balance through the media database 150.

The consumption policy module 145 may support additional means for funding an account through periodic (i.e., monthly) payments of a pre-determined amount of money being added to the account. For example, the content subscriber 1020 may set up their account to add $30/month to their account balance. Therefore, each month, the content subscriber may connect the media disk 100 and/or the media player 200 to the Internet to update the new balance. Alternatively, the content provider 1010 may provide a new credit key or key card to the content subscriber 1020 to enter into the media disk 100 and/or the media player 200, hence updating the media database 150 and/or 275 with this information.

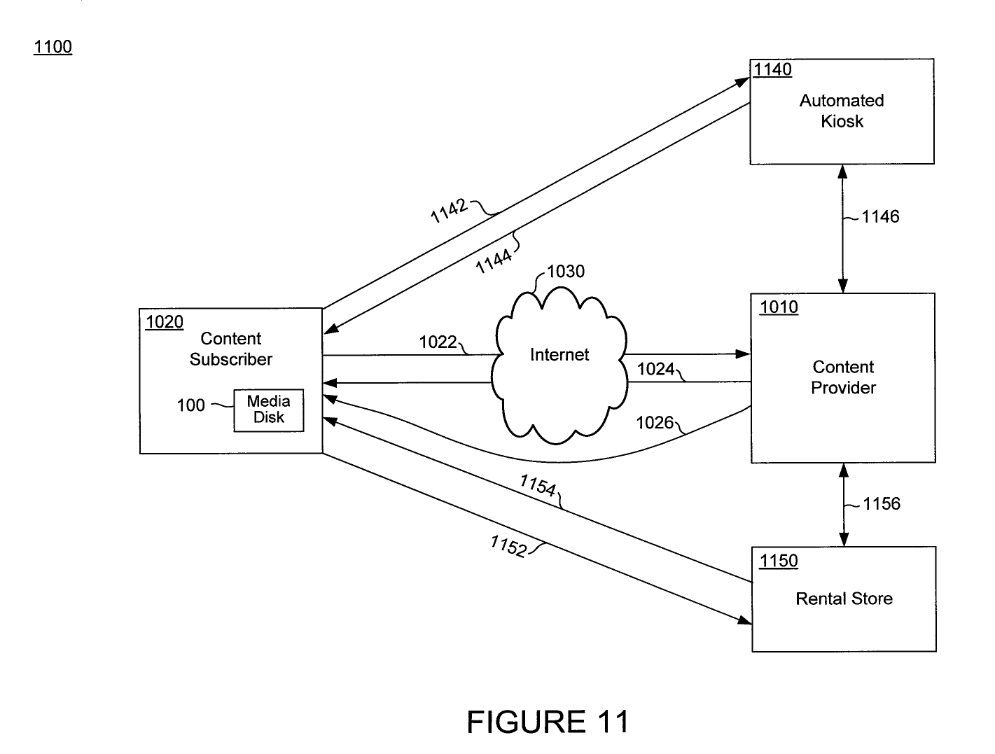

The consumption policy module 145 may permit a second payment format relying on a credit-based approach. Under this system, the consumption policy module 145 may allow the content subscriber 1020 to rent content at will, regardless of any balance in their account. Periodically, the content subscriber's 1020 account is charged any outstanding balance. Such a system may have an existing credit card or bank account associated with the account, such that funds may be withdrawn automatically at periodic intervals or when the balance owed reaches a predetermined limit. The media disk 100 and/or the media player 200 may be systematically connected to the Internet to transmit the rental information to the content provider 1010. Alternatively, the media disk 100 may be shipped back the content provider 1010 or connected to a kiosk or rental store (described in FIG. 11). Once the rental information is received, the content provider 1010 will know how much to charge the content subscriber's 1020 account. Once the amount is charged, the content provider 1010 may provide an additional credit key or key card to the content subscriber. Once the credit key or key card is entered, the consumption policy module 145 may update the account balance via the media database 150.

In another embodiment, different media content types may all have the same rental value or cost. As such, the cost for renting a movie, a single television show (regardless of length) or a music CD may all have the same rental cost.

In another embodiment under the transaction-based rental model, the cost of a rental may directly relate to the viewing period of the media content. In other words, the cost of viewing a movie may vary depending on the time period in which the rental may be viewed. For example, a movie rental may cost $4 if the viewing period is 30 days from the time the viewing begins. The movie may be viewed multiple times during that viewing period without incurring additional charges. In another example, a movie rental may only cost $1 if the viewing period is reduced to 24 hours from the time the viewing begins and the movie may only be watched once.

In another embodiment relating to both rental models, the consumption policy module 145 may permit the cost of renting content based on additional factors such as the release date of the content (new releases may cost more than older movies), running time (three hour movies may cost more than 90 minute movies), etc. In another embodiment, a subscription-based rental model may have different monthly costs based on additional factors of the types of movies rented. For example, a $15/month subscription agreement may permit rental of ten movies whose release date is older than one year. Whereas, a $20/month agreement may permit rental of ten new release movies or 15 older release movies or any combination thereof.

The consumption policy module 145 may also vary the cost of renting content based on the audio-visual quality of the content. For example, the content subscriber 1020 may request that all movies be provided in as high of a video resolution as possible (i.e., 720p, 1080i, 1080p, etc.) and the highest audio quality and number of audio channels (i.e., 7.1 surround with a bandwidth of 3 Mbps). Alternatively, the content subscriber 1020 may request the content be in a 640×480 video resolution with only stereo sound at 128 Kbps bandwidth. Hence, each version of the same content may have different costs.

All the examples used above are merely examples and are not meant to limit the scope of the invention. One skilled in the art is aware that many additional examples may be used to describe the above rental models. Additionally, the functionality of the differing rental agreement models may be enforced by other modules aside from the consumption policy module 145. For example, the RAE 285 may be responsible for such enforcement.

Returning to FIG. 10, the content subscriber 1020 makes a request 1022 for media content, which in one embodiment the request is transmitted over the Internet 1030, to content provider 1010. In alternative embodiments, the request 1022 may be transmitted through a local area network (“LAN”), wide area network (“WAN”), personal area network (“PAN”), RFID, Near Field Communications, telephone or other transmission medium known by those skilled in the art. In one embodiment, the content subscriber 1020 may initiate the request 1022 through a website associated with the content provider 1010. In another embodiment, the request 1022 may be initiated through a client-based software application installed on a local computer. In yet another embodiment, the request 1022 may be initiated directly from the media disk 100 and/or the media player 200 through the internet 1022, postal mail 1028, via a kiosk, or a rental store. Upon receipt of the content request 1022, the content provider 1010 may transmit the requested content 1024 back to the content subscriber 1020 via the Internet 1030 (assuming the content subscriber 1020 already has a media disk 100). Depending on the amount of content requested 1022, the time for downloading may vary greatly. An advantage of this method of delivery is that the content subscriber 1020 may begin the download of content and allow it to run all night. Hence, when the content subscriber awakes, their requested content 1022 has arrived.

In one embodiment, the transmission protocols used for delivering the requested content 1024 to the content subscriber 1020 may include, but are not limited to HTTP, FTP, peer-to-peer (“p2p”) such as torrents, IRC, RSS, SMTP, IMAP, POP3, telnet or any other application layer protocols supported by TCP/IP.

Alternatively, if a new customer does not have a media disk 100 in their possession, their requested content 1022 from above may be installed on a media disk 100 by the content provider 1010. Then, the content provider 1010 can mail 1026 the media disk to the content subscriber 1020 via postal mail or other forms of physical delivery such as hand delivery via a courier. Additionally, the content subscriber 1020 may wish to have additional media disks 100 as part of their rental agreement. Further, depending on the number of content requests 1022 requested, it may be impractical to download the content from the Internet 1030. Hence, an additional and/or substitute media disk 100 may be shipped 1026 to the content subscriber 1020 with or without an additional charge.

FIG. 11 illustrates another embodiment of an expanded media content delivery system 200. As with FIG. 10, content subscriber 1020 may request 1022 and receive media content 1024 from the content provider 1010 via the Internet 1030 or by physical shipment 1026. However, in another embodiment, the content subscriber 1020 may physically visit an automated kiosk 1140 to receive media content and/or a media disk 100. An automated kiosk 1140 may provide an interface permitting the content subscriber 1020 to request content 1142 for download to their media disk 100. In one embodiment, media disk 100 may be physically connected to automated kiosk 1140. The media disk 100 may have an Ethernet port for communication 1142 with kiosk 1140 through TCP/IP protocols. Alternatively, the media disk 100 may use USB, Firewire, standard, or proprietary connectors to communicate 1142 with the kiosk 1140 through their respective bus protocols. In another embodiment, the media disk 100 may possess wireless technology, permitting communication 1142 with the kiosk 1140 through wireless protocols such as 802.11a, b, g or n.

Once a communication link is established between the media disk 100 and the kiosk 1140, media content requests may be communicated to the kiosk 1140 through one of many input devices attached to the kiosk 1140. For example, the kiosk 1140 may have a touch screen, keyboard and mouse or any other input device known in the art. Upon receipt of a content request 1142, the kiosk 1140 is able to provide the requested content 1144 to the media disk 100 through one of the transmission mediums described above. In one embodiment, the kiosk 1140 contains internal storage for storing some or all of the media content available from the content provider 1010. If the requested content resides within the kiosk's 1140 internal storage, the content is provided to the media disk 100 for download. Alternatively, if the requested content does not reside locally within the kiosk 1140, a communication link 1146 from the kiosk 1140 to the content provider 1010 may be used. In one embodiment, this communication link 1146 exists across the Internet 1030. In another embodiment, the communication link 1146 bypasses the Internet and is part of a WAN, LAN, Storage Area Network (“SAN”) or a similar network. If the requested content is not locally available on the kiosk 1140, the content request 1122 is relayed through a communication link 1146 to the content provider 1010. The content provider 1010 receives the request and transmits the requested content 1024 to the kiosk 1140. The kiosk 1140 is then able to forward the content to the media disk 100 for download. Communication link 1146 may be a secured connection over the Internet, Virtual Private Network (“VPN”) or other protocols that ride on top of a WAN or LAN.

In one embodiment, automated kiosks may be physically located in a number of locations including but not limited to retail establishments, restaurants, grocery stores, airports, coffee shops and train and bus terminals.

In addition to the transmission of content to a content subscriber 1020, the kiosk 1140 may provide additional functionality. For example, a new customer may approach the kiosk 1140 and sign up for a rental agreement. Through the input terminal, the new customer may sign up for service in a similar fashion as may be done through a website associated with the content provider 1010. Credit card slots may exist on a kiosk permitting immediate payment of a chosen rental agreement. Further, a kiosk 1140 may also dispense a media disk 100 to the new customer, complete with the requested content.

Additionally, an existing user such as content subscriber 1020 may make payments associated with their rental agreement through the credit card interface of a kiosk. Further, a current customer wishing to cancel service may do so at a kiosk by depositing their media disk 100 into the kiosk 1140.

In yet another embodiment, a kiosk 1140 may permit a content subscriber 1020 to exchange their media disk 100 for a new one. Such a scenario may be common when the existing content on a media disk 100 is no longer desirable. The content subscriber 1020 can turn in their media disk 100 and request an exchange disk with new content (e.g., generic content or custom content organized by the kiosk 1140).

In another embodiment, pre-packaged content sets may exist on media disks. For example, a content subscriber may purchase, rent or exchange their existing media disk 100 for a new media disk 100 containing: the Top 100 movies of all time, greatest romance/action/horror/suspense movies; top new releases, children movies approved by parents-choice.org or similar organizations.

Another means for requesting and receiving media content is through a rental store 1150. A rental store 1150 may be a brick and mortar establishment with employees. A content subscriber 1020 may visit the store 1150 and request content 1152 from an employee. The employee may then connect the media disk 100 to a transmission medium as described above in regards to kiosk 1140. The requested content may then be transmitted 1154 to media disk 100. If the requested content 1152 is not available at the rental store 1150, a communication link 1156 may be used to request and retrieve content from the content provider 1010. Additionally, new customers may also sign up for a rental agreement, request content and receive a media disk 100 containing the requested content as described above in regards to kiosk 1140. Lastly, a customer wishing to cancel service may do so by relinquishing their media disk 100 to a store 1150.

In addition to the content subscriber 1020 receiving media content via download from either the content provider 1010, a kiosk 1140 or a store 1150, the pre-requesting of content is also available. For example, if the content subscriber 1020 wishes to receive new content, they may make such requests to a website associated with the content provider 1010. In contrast to having the content immediately downloaded to the media disk 100, the content subscriber 1020 may request pick up of a new media disk 100 at either a kiosk 1140 or a store 1150. Such an approach allows the requested content to be downloaded to a new media disk 100 at the desired pickup location. After a period of time, the content subscriber 1020 may visit the location and exchange their current media disk 100 for a new one containing the requested content. There are many advantages to this approach over the downloading of content from an Internet connection. The bandwidth used to download numerous movies could be time restrictive based on today's common bandwidth speeds of 1.5 Mbps to 6.0 Mbps. Further, download restrictions are common amongst ISPs, such that downloading numerous movies may exceed a pre-set limit, resulting in additional bandwidth fees for the subscriber. Additionally, differing copyright licensing issue may exist between the content provider 1010 providing content via Internet download versus a physical kiosk.

Additionally, a rental store 1150 may also permit the same pre-packaged media disks as provided by a kiosk 1140. Additionally a kiosk 1140 and a rental store 1150 may offer media disks and media content for purchase

In yet another embodiment, a content subscriber 1020 may also visit a kiosk 1140 or a store 1150 and download content to other devices aside from a media disk 100. For example, cellular phones such as the iPhone™, Blackberry™, MP3 players such as the iPod™, laptops and other portable media devices are capable of playing the types of media content offered by the content provider 1010. Hence, kiosks 1140 and stores 1150 may provide connection ports that are common amongst these media devices, permitting download of content onto the devices. In order to provide proper security and access rights to the content stored on alternate media devices, a software application may be downloaded to the device. This software application may provide similar functionality as the viewing policy engine 2800 and the rental agreement engine 285 as described above in regards to FIGS. 1-10.

It should further be noted, that other mechanisms may exist for the transfer of content to a content subscriber. The included examples are merely examples and are not meant as a complete list of available options.

In addition to requesting content, via the Internet 1030, from the content provider 1010, other means for making content requests may be used. For example, a cable television receiver or satellite television receiver may provide an interactive interface for requesting and downloading such content. Additionally, a telephone may be used to request content through either automated menus, live representatives or SMS text messages. Once a request for content is received, the content provider 1010 may direct delivery of the content via the Internet 1030, a kiosk 1140 or rentalstore 1150 or physical shipment of a media disk 100 to the content subscriber 1020 directly from the content provider 1010, or a kiosk 1140 or a rental store 1150.

The media disk 100 has a finite amount of storage, therefore, one or more means for removing content may be used. In one embodiment, content may have a pre-determined shelf-life. For example, content residing on a media disk 100 for longer than six months may be automatically deleted. Additionally, content may be deleted after it has been viewed or after its rental viewing period ends. Further, content subscriber 1020 may mark individual items for manual deletion. In another embodiment, content may reside in storage until additional storage is needed for new content. For example, if the content subscriber 1020 requests new content from one of the above transmission mediums (1030, 1140 1028 or 1150) the media disk 100 may pre-determine the storage requirements for the requested content. If the available storage space is insufficient for the addition of the content, the content subscriber 1020 may be asked which existing content they want deleted. Alternatively, media disk 100 may use one or more methods for automatic deletion of content, such as deleting the oldest content first.

In another embodiment, a portion of the media disk's 100 storage device may be reserved for content downloaded by other means such as computer, DVR, other media disks, etc.

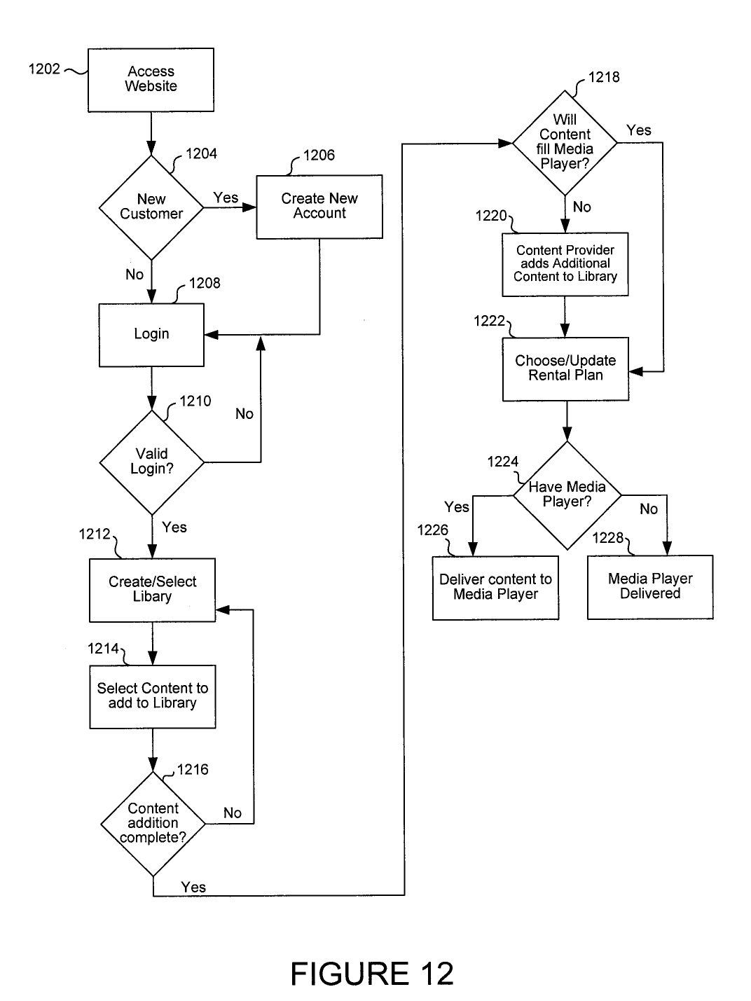

FIG. 12 is a flow diagram illustrating a method for requesting and receiving media content from a content provider 1010. The order of the these steps may vary without limiting the scope of the invention. Further, additional steps may be added, existing steps split, or removed without limiting the scope of the invention. In one embodiment, a user begins by accessing a website associated with the content provider 1010 (step 1202). This may include third party websites who have contracted with the content provider 1020 to provide content. If the user is a new customer (step 1204), then the user creates a new account (step 1206). The creation of a new account may require placement of a credit card, bank account or other financial payment account on file. If the user is an existing customer (i.e., content subscriber 1020), they will be asked to log in to their account (step 1208). If the login is valid (step 1210), the content subscriber 1020 is permitted to create or select a content library (step 1212). If an existing library is selected, its contents may be displayed to the content subscriber 1020. If a new library is created, it begins as an empty library or filled partially or completely by the recommended engine, permitting the addition of content by the content subscriber 1020.

In one embodiment, once a library has been selected or created by the subscriber, provider or other source, a catalog of available content may be provided to the content subscriber 1020. The content subscriber 1020 may search for content based on a plethora of search criteria. In regards to movies, search criteria may include: movie genre, MPAA rating, release date, director, actor/actress, awards and many others. Other media content types (i.e., television shows, documentaries, music, computing games, etc.) may have differing sets of search criterion.

### Content Channels

In another embodiment, the selection of content is not limited to searching a catalog provided by the content provider 1010. Additionally, content channels may also be used. A content channel is the grouping of media content based on some unifying characteristic. For example, a content channel may include content based on a specific television channel, all television documentaries based on World War II, the American Film Institute's Top 100 Films, or any other criteria. Many types of content channels may exist. First are subscriber-created channels. For example, the content subscriber 1020 may create their own content channel based on their recommended movies from the year 2007. In one embodiment, content channels may be broadly published to the content provider's 1010 website, shared on social networking websites, or may be shared with specific contacts, or not shared at all. Such publication permits other content subscribers to view the subscriber-created content channel and elect to add content based on the channel.

Additionally, the content provider 1010 may create content channels based on material they find desirable. For example, the content provider 1010 may create a content channel based on the top 50 rented movies by other content subscribers. As a default, the content provider 1010 may pre-load a media disk 100 with this content. Therefore, a content subscriber may choose this content channel, knowing they will receive the most popular content amongst other content subscribers. Lastly, content channels may be created by third parties. In regards to third party content channels, an entity such as The New York Times™ may create their own content channel based on their top 20 movies of the year 2007. Other third party examples may include movie studios creating channels based on their own content.

A content subscriber 1020 may select some or all of the content associated with a content channel. In another embodiment, a content subscriber 1020 may subscribe to a content channel. A subscription would then keep the subscriber 1020 up to date as new content is added to the channel. In one embodiment, as content is added to the subscribed content channel, the content subscriber's 1020 rental agreement may automatically add the additional content to their library which may be downloaded to the media disk 100. Alternatively, the content subscriber may choose a maximum amount of new content (from the subscribed channel) to add to the library and/or download to the media disk 100. For example, a maximum of five movies from the subscribed channel may be downloaded to each media disk 100 associated with the subscriber 1020 each time the media disk is filled by the content provider 1010, a kiosk 1140 or a rental store 1150.

As previously stated, the subscriber 1020 may select specific content from a content channel to add to their media disk 100. For example, the subscriber 1020 may skip some episodes in a television series or some already consumed content. Additionally, the subscriber 1020 may also choose the number of items to add to a media disk 100 each time the media disk 100 is refreshed with new content over the Internet 1030, a kiosk 1140, a rental store 1150 or by the content provider 1010 and then mailed back. For example, the subscriber 1020 may have multiple channels selected to add content to the media disk 100. The subscriber 1020 may elect to have more of one channel's content than another channel.

In another embodiment, a channel editor may be available to subscribers, providers or other third parties. A channel editor permits for the creation, deletion or modification of a channel as well as the ability to aggregate multiple channels into a single channel. For example the subscriber 1020 may like the content of two or more currently existing channels and wish to combine them into one channel. Additionally, the subscriber 1020 may edit the combined channel to filter out certain material based on one or more filter criterion.

As previously stated, a content subscriber 1020 may have multiple media disks 100 which they own or rent. For example, a subscriber 1020 having a Disk “A” and a Disk “B” may choose different content channel choices for each Disk. For example the subscriber 1020 may have selected the “Western” channel and the “Film Festival Channel” and choose to have the Western channel associated with Disk “A” while having the “Film Festival Channel” associated with disk “A” and Disk “B”.

In another embodiment, a subscriber 1020 may also choose to have content channels automatically loaded onto their media disk 100 based on a date range or season. For example, the subscriber 1020 may select the “Horror Movie” channel to be added to the disk during the month of October. In this case any disk shipped in October may include the number of movies the subscriber 1020 selected for that season or date range. A date range is arbitrarily small or large.

A subscriber 1020 may also choose to have a specific content channel loaded onto their media disk 100 on certain intervals of refreshing the disk. For example, the subscriber 1020 may want to select the “Documentary” channel for download, but may not want to see the content on every refresh interval. In this case, the subscriber 1020 may choose to limit the loading of the “Documentary” channel to every other or every third disk shipped or refreshed by the content provider 1010.

A subscriber 1020 may also choose to have a logical combination of channels such that loading of content from one channel is dependent on the loading of content from other channels. For example, a subscriber 1020 may choose to have a movie loaded from Channel A only if there is one movie from Channel B, two movies from channel C, but no movies from Channel D. The logical operations consist of typical Boolean operators such as AND, OR, NOT, XOR, etc. A more sophisticated approach may include the concept of a storage element to create a state machine in the Moore or Mealy models. The state machine storage element could be represented by the current disk, a future disk, or a previous disk's content.

Additionally, a content provider 1010 may create a channel specific to a subscriber which provides a specific set of content tailored to the subscriber's tastes, preferences, and previous viewing history. This channel may be created by a recommendation engine, a person or other methods.

Returning to FIG. 12, once content is selected, it is added to the library (step 1214). When all the desired content is added to the library (step 1216), a check may be made to determine whether the content placed into the library would fill up the media disk's 100 storage capacity (step 1218). In other words, would the storage device of the media disk 100 have free space after the addition of the content from the library. If there is additional storage space, additional content may be added to the library in order to fill the media disk 100 to full capacity (step 1220). In one embodiment, the additionally added content may be based on one or more characteristics related to the selected content or channels. For example, if the content subscriber 1020 selected horror movies to add to the library, additional horror movies may be added to fill up the media disk 100. In another example, if the content subscriber 1020 selected movies that won academy awards, the additionally selected content may include movies that have won best picture.

Once the library contains enough content to fill the media disk 100 to capacity, the content subscriber 1020 may select a rental agreement (step 1222). Alternatively, if the content subscriber 1020 is already a customer with an existing rental agreement, changes to the current rental agreement are permitted. Once a rental agreement is selected or possibly updated by the content subscriber 1020, a determination is made as to whether the content subscriber 1020 already has a media disk 100 (step 1224). If the content subscriber 1020 has a media disk 100, one or more delivery mechanisms are used to transmit the content (step 1226) to the content subscriber 1020.

In one embodiment, the content subscriber 1020 may bring their existing media disk 100 to an automated kiosk 1140 or store 1150. The selected content may be downloaded to the media disk 100 while the content subscriber 1020 waits. In another embodiment, the content subscriber 1020 may exchange their current media disk 100 for a new one (containing the selected content from the library for which they selected content via the content subscriber's website. Such an exchange can occur at a kiosk 1140, a store 1150 or the mail 1028. In another embodiment, within the website, the content subscriber 1020 may search for and choose a specific kiosk 1140 or store 1150 in which to exchange their media disk 100.

Alternatively, the content subscriber 1020 may elect to have a new media disk (containing the selected content) shipped to them 1028. Once received, the content subscriber 1020 may return their existing media disk 100 to the content provider 1010, an associated kiosk 1140 or rental store 1150. In the alternate, a new media disk may be withheld for shipment until the old media disk 100 is received by the content provider 1010, an automated kiosk 1040 or a rental store 1050. Additionally, the content subscriber 1020 may connect their media disk 100 to a computer, routing device, an Internet connected media player, set top box, or a game console, permitting the selected content to download directly to their media disk 100.

Content subscriber 1020 may also select certain content on the media disk 100 that is to remain on any media disk they possess including the swapping of one disk for another. For example, when a media disk 100 is returned to the content provider 1010, kiosk 1140, or rental store 1150, the new disk delivered to the subscriber 1020 may always contain purchased content until it is manually transferred off the media disk 100 by the subscriber 1020 onto a purchased media disk 100, DVD or other media.

If the content subscriber 1020 is a new customer or does not currently have a media disk 100, a media disk 100 is provided (step 1228) through one of the delivery mechanisms mentioned above. For example, the content subscriber 1020 may have a media disk 100 (containing the selected content) mailed to them or local pickup from a kiosk 1140 or a rental store 1150. Additionally, a content subscriber 1020 may also request a media player 200 as described in FIG. 9. Such a media player 200 may be purchased or rented from the content provider 1010, a kiosk 1040, a rental store 1050 or other third parties.

In another embodiment, a media disk 100 may be delivered to a content subscriber 1020 with a complete catalog of all the content available by the content provider 1010. The content subscriber 1020 may then search the complete catalog without need for an Internet connection or access to a kiosk 1140. Content may then be selected from the catalog. The content subscriber 1020 may then ship the media disk 100 back to the content provider 1010. The content provider 1010 may then download the selected content to a media disk 100 and ship it back to the content subscriber 1020. In another embodiment, the content subscriber 1020 may take the media disk 100 to a kiosk 1140 or a rental store 1150 or connect the disk 100 to the Internet 1030. The media disk 100 may be connected to the kiosk or rental store and the selected content from the full catalog may be downloaded. Further, all media disks 100 may have a portion of the storage space set aside for hosting the full or partial catalog of available content. Therefore, a content subscriber 1020 is always able to search for content without the need for Internet access.

Further to this embodiment, a mechanism may exist to synchronize requests made by the content subscriber 1020 for new movies to be placed on the next media disk 100 via a connected means (e.g., the Internet, kiosks and rental stores) with requests made by the content subscriber 1020 for new movies via a non-connected means (e.g., requests made via an unconnected media player). Requests made from an unconnected media player may be communicated to the content provider 1010, a kiosk 1140, or a rental store 1150 when a media disk is returned, or an SMS text message from cell phone requesting new content, or any other means whereby requests are made for new content but the actual management for the next disk is not carried out. One such synchronization method is to prioritize requests made in connected and non-connected modes so that the more recent requests have higher priority. Such a scenario may exist if all the requested content can not fit on the media disk 100.

In another embodiment, the content subscriber 1020 may have multiple media disks 100 and/or media players 200. The rental agreement associated with the content subscriber 1020 may apply individually to each media disk or be encompassing of all the media disks. In yet another embodiment, if subscriber A brings disk A to subscriber B's media player to play content, the rental of content may be charged to the owner of disk A (i.e., subscriber A). In another embodiment, the owner of the media player, (i.e., subscriber B) may be charged for the rental.

### Electronic Games

As previously mentioned, computing and console games may also be delivered onto a media disk 100. Such content may also be restricted to use based on the same policies enforced by the VPE 280 and RAE 285 in regards to movies. The VPE and RAE modules may be downloaded to the computer or gaming console for which the content is directed. Therefore, the gaming device is able to enforce the policies. The VPE and RAE may be transmitted to the gaming device via Internet, a media disk 100, a media player 200, etc. If a subscriber is permitted to play a game, based on their associated rental agreement and viewing policy, the game is downloaded to the gaming device or computer and the subscriber may begin playing.

In conclusion, the present invention provides, among other things, a system and method for providing media content to a content subscriber. Those skilled in the art can readily recognize that numerous variations and substitutions may be made in the invention, its use and its configuration to achieve substantially the same results as achieved by the embodiments described herein. Accordingly, there is no intention to limit the invention to the disclosed exemplary forms. Many variations, modifications and alternative constructions fall within the scope and spirit of the disclosed invention as expressed in the claims.

What is claimed is:

1. A media device for controlling access to media content comprising:
a processor;
a memory;
a storage device housing for accepting a storage device;
a media database for storing information related to a group of media content residing on the storage device;
a first communication interface for communicating with an external device;
a second communication interface for communicating with an external device;
a real-time clock mechanism for maintaining a timestamp; and
a viewing policy engine for controlling access to the group of media content residing on the storage device.

2. The media apparatus of claim 1, further comprising:
a rental agreement engine for enforcing a rental policy associated with the storage device.

3. The media apparatus of claim 1, further comprising:
a display for displaying a visual aspect of the group of media content;
a speaker for reproducing an audio aspect of the group of media content;
a set of audio and video outputs for transmitting the visual and audio aspect of the group of media content to a second apparatus; and
an input device for directing a request to the media apparatus.

4. The media apparatus of claim 1 wherein the viewing policy engine further comprises:
a content management module for managing the media content stored in the storage device, the content management module further monitoring which media content has been viewed from the storage device;
a pre-release management module for managing access to media content based on a release date of the media content, wherein access to the media content is denied while the media content's release date is less than a current date; and
a content ownership module for managing access to media content wherein the media content is owned by a content subscriber.

5. The media apparatus of claim 4 wherein the viewing policy engine further comprises:
a subscription verification module for verifying a validity of a rental agreement associated with the media apparatus;
a consumption policy module for enforcing a group of rules associated with a rental agreement type, wherein the rental agreement type is transaction-based or subscription-based;
a parental control module for controlling access to media content based on an age rating of the media content; and
a digital rights management module for enforcing a digital right associated with the group of media content.

6. The media apparatus of claim 5, wherein the subscription verification module denies access to the group of media content while the rental agreement is invalid and the group of media content is not owned by the content subscriber.

7. The media apparatus of claim 4, wherein the content management module updates the media database when a portion of the group of media content is accessed.

8. The media apparatus of claim 1 wherein the group of media content is selected from the group consisting of: movie, television show, documentary, commercials, music and a computing game.

9. A system for providing media content to a user, comprising:
a media apparatus;
a content provider to provide media content to the first media apparatus, the content provider comprising:
a first data storage for storing subscription information associated with the first media storage device;
a second data storage for storing media content;
a delivery module for providing media content to the first media apparatus device; and
a request module for receiving requests for media content.

10. The system of claim 9, further comprising:
an automated kiosk communicatively coupled to the content provider, the automated kiosk to provide media content to the media apparatus.

11. The system of claim 9, further comprising:
a media store communicatively coupled to the central content provider, the media store to provide media content to the media apparatus.

12. The system of claim 10, wherein the automated kiosk further comprises:
a kiosk communication interface for communication with the media apparatus and the central content provider; and
a kiosk storage device for storing media content.

13. The system of claim 10, wherein the automated kiosk is able to provide media content to a third party media device.

14. A method for providing media content to a content subscriber, comprising the steps of:
receiving from a content subscriber a rental request for a first digital media file;
providing the first digital media file to the content subscriber, wherein the first media file is stored on a media apparatus associated with the content subscriber;
flagging the first media file as rented when the first media file is viewed; and
applying the first media file to a rental agreement associated with the content subscriber when the first media file is flagged as rented.

15. The method of claim 14 further comprising:
removing a second digital media file from the media apparatus if the second media file is flagged for removal.

16. The method of claim 14 further comprising:
providing a third digital media file to the content subscriber wherein the third digital media file is associated with a content channel subscribed to by the content subscriber.

17. The method of claim 14 further comprising:
removing a fourth digital media file from the media apparatus when the fourth digital media file is flagged as expired.

18. The method of claim 14 further comprising:
flagging a fifth digital media file as owned when the content subscriber purchases the fifth digital media file; and
applying the purchase of the fifth media file to an ownership policy associated with the content subscriber.

19. The method of claim 14 further comprising:
denying access to the first digital media file until a current date is greater than or equal to a release date for the first digital media file.

20. The method of claim 14 further comprising:
associating a preview period to the first digital media file wherein the first digital media file may be viewed for a preview period such that the first digital media file is flagged as not rented, the preview period showing a predetermined portion of the first digital media file.

21. The method of claim 14 further comprising:
providing a catalog of media content to the media apparatus, wherein the content subscriber can search the catalog based on one or more search criterion.

22. The method of claim 14 further comprising:
suggesting a sixth digital media file to the content subscriber based on one or more previously viewed digital media files.

23. The method of claim 14 further comprising:
applying the first digital media file to a rental agreement associated with a second content subscriber when the first digital media file is flagged as rented by the second content subscriber.

24. The method of claim 14 wherein the first digital media file is provided to the media apparatus from a location selected from the group consisting of: a content provider, an automated kiosk, and a rental store.

25. The method of claim 16, wherein the content channel is a collection of media content with one or more common characteristics such that the media content is associated with the content channel.
